(19) United States
(12) Patent Application Publication
(10) Pub. No.: US 2023/0133238 A1
(43) Pub. Date: May 4, 2023

(54) METHOD AND APPARATUS FOR TRANSMITTING FEEDBACK OF HYBRID AUTOMATIC REPEAT REQUEST IN WIRELESS COMMUNICATION SYSTEM

(71) Applicant: Samsung Electronics Co., Ltd., Suwon-si (KR)

(72) Inventors: Jingxing FU, Beijing (CN); Feifei SUN, Beijing (CN); Sa ZHANG, Beijing (CN)

(21) Appl. No.: 17/975,990

(22) Filed: Oct. 28, 2022

(30) Foreign Application Priority Data
Oct. 29, 2021 (CN) 202111275198.0

(51) Int. Cl. H04L 1/18; H04W 72/12; H04W 76/30

(52) U.S. Cl. CPC H04L 1/1812; H04W 72/1273; H04W 76/30

(57) ABSTRACT

The disclosure relates to a 5G or 6G communication system for supporting a higher data transmission rate. A method performed by a user equipment (UE) is provided. The method includes: receiving first configuration information from a base station, configuring a mode of feeding back hybrid automatic repeat request acknowledgement (HARQ-ACK) information based on the first configuration information, and transmitting the HARQ-ACK information according to the first configuration information.

### CROSS-REFERENCE TO RELATED APPLICATION(S)

This application is based on and claims priority under 35 U.S.C. § 119(a) of a Chinese patent application number 202111275198.0, filed on Oct. 29, 2021, in the Chinese Intellectual Property Office, the disclosure of which is incorporated by reference herein in its entirety.

### BACKGROUND

### 1. Field

The disclosure relates to the technical field of communication. More particularly, the disclosure relates to a method and device for transmitting hybrid automatic repeat request acknowledgement (HARQ-ACK) information.

### 2. Description of Related Art

### DISCLOSURE

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, New Radio (NR) User Equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide efficient communication methods in a wireless communication system.

Another aspect of the disclosure is to provide a method, apparatus and device for transmitting hybrid automatic repeat request acknowledgement (HARQ-ACK) information, and a computer-readable storage medium, which can at least solve one of the technical deficiencies in the existing communication mode, further improve the communication mode and better satisfy the actual communication requirements.

Additional aspects will be set forth in part in the description which follows and, in part, will be apparent from the description, or may be learned by practice of the presented embodiments.

In accordance with an aspect of the disclosure, a method performed by a user equipment (UE) is provided. The method includes receiving first configuration information from a base station, configuring a mode of feeding back hybrid automatic repeat request acknowledgement (HARQ-ACK) information based on the first configuration information, and transmitting the HARQ-ACK information according to the first configuration information.

In accordance with another aspect of the disclosure, a method performed by a base station is provided. The method includes steps of transmitting first configuration information to a user equipment (UE), and receiving hybrid automatic repeat request acknowledgement (HARQ-ACK) information based on the first configuration information, wherein the first configuration information is used to configure a mode of feeding back the HARQ-ACK information.

In accordance with another aspect of the disclosure, a user equipment (UE) is provided. The UE includes a transceiver and a processor coupled with the transceiver and configured to receive first configuration information from a base station, configure a mode of feeding back hybrid automatic repeat request acknowledgement (HARQ-ACK) information based on the first configuration information, and transmit the HARQ-ACK information based on the first configuration information.

In accordance with another aspect of the disclosure, a base station device is provided. The base station includes a second transmitting module configured to transmit first configuration information to a user equipment (UE), the first configuration information being used to configure a mode of feeding back HARQ-ACK information; and a second receiving module configured to receive HARQ-ACK information according to the first configuration information.

In accordance with another aspect of the disclosure, an electronic device is provided. The electronic device includes a processor, a memory, a communication interface and a communication bus, the processor, wherein the memory and the communication interface are communicated with each other through the communication bus; and the memory is configured to store at least one executable instruction that cause the processor to execute the operations corresponding to the method described in the first aspect of the disclosure.

Optionally, the electronic device may be a user equipment, and the processor can execute the method executed by a UE described in the first aspect of disclosure application when running the computer programs.

Optionally, the electronic device is a base station, and the processor executes the communication method executed by a base station described in the second aspect of the disclosure when running the computer programs.

In accordance with another aspect of the disclosure, a computer-readable storage medium having computer programs stored thereon that, when executed by a processor, implement the method described in the first aspect of the disclosure is provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The detailed description and discussion of one or more embodiments of the subject matter of the present invention will be set forth to a person of ordinary skill in the art in the following description with reference to the accompanying drawings.

The present invention will be more easily understood by the following detailed description of the accompanying drawings, wherein the same reference numerals indicate the units having the same structure, and wherein:

FIG. 1 shows an example diagram of a wireless network according to various embodiments of the disclosure;

FIG. 2A shows an example diagram of wireless transmission according to an embodiment of the disclosure;

FIG. 2B shows an example diagram of a receiving path according to an embodiment of the disclosure;

FIG. 3A shows an example diagram of a UE according to an embodiment of the disclosure;

FIG. 3B shows an example diagram of a gNB according to an embodiment of the disclosure;

FIG. 4 shows a flowchart of an exemplary method according to an embodiment of the disclosure;

FIG. 5 shows a schematic diagram of a specific example of transmitting HARQ-ACK information according to an embodiment of the disclosure;

FIG. 6 shows a schematic diagram of an example of transmitting HARQ-ACK information according to an embodiment of the disclosure;

FIG. 7 shows a schematic diagram of another example of transmitting HARQ-ACK information according to an embodiment of the disclosure;

FIG. 8 shows a schematic diagram of another example of transmitting HARQ-ACK information according to an embodiment of the disclosure;

FIG. 9 shows a schematic diagram of another example of transmitting HARQ-ACK information according to an embodiment of the disclosure;

FIG. 10 shows a schematic diagram of another example of transmitting HARQ-ACK information according to an embodiment of the disclosure;

FIG. 11 is a block diagram of a structure of a UE according to an embodiment of the disclosure; and

FIG. 12 is a block diagram of a structure of a base station (BS) according to an embodiment of the disclosure.

Throughout the drawings, it should be noted that like reference numbers are used to depict the same or similar elements, features, and structures.

### BEST MODE

### Mode for Invention

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, denotes to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” denotes any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, denotes that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The embodiments of the disclosure will be described in detail below, and the examples of the embodiments are illustrated in the accompanying drawings, throughout which the same or similar reference numerals refer to the same or similar elements or elements having the same or similar functions. The embodiments to be described below with reference to the accompanying drawings are exemplary, and are only used for explaining the disclosure, rather than being construed as limiting the disclosure.

It should be further understood that the term “comprise/comprising” used in the specification of the disclosure specifies the presence of the stated features, integers, steps, operations, elements and/or components, but not exclusive of the presence or addition of one or more other features, integers, steps, operations, elements, components and/or combinations thereof. It should be understood that, when a component is referred to as being “connected” or “coupled” to another component, this element may be directly connected or coupled to the another element, or there may be intervening elements therebetween. In addition, as used herein, the “connection” or “coupling” may comprise wireless connection or wireless coupling. As used herein, the term “and/or” comprises all or any of one or more associated listed items or combinations thereof.

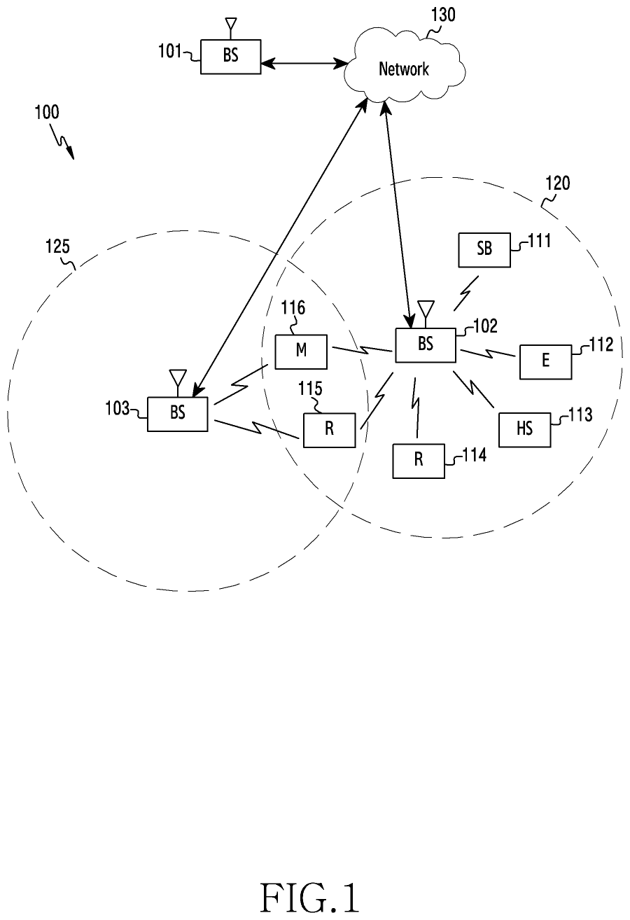

FIGS. 1 to 12 discussed below and various embodiments used for describing the principle of the disclosure in this patent document are merely illustrative, and shall not be construed as limiting the scope of the disclosure in any way. It should be understood by those skilled in the art that the principle of the disclosure can be implemented in systems or devices in any suitable arrangement.

FIG. 1 shows an exemplary wireless network 100 according to various embodiments of the disclosure.

Referring to FIG. 1, the embodiment of the wireless network 100 is merely for the purpose of illustration. Other embodiments of the wireless network 100 can be used without departing from the scope of the disclosure.

The wireless network 100 comprises a gNodeB (gNB) 101, a gNB 102 and a gNB 103. The gNB 101 communicates with the gNB 102 and the gNB 103. The gNB 101 also communicates with at least one Internet protocol (IP) network 130 (e.g., Internet, private IP networks or other data networks).

Depending upon the network type, other well-known terms such as “base station” or “access point” can be used to replace “gNodeB” or “gNB”. For convenience, the terms “gNodeB” and “gNB” are used in this patent document to refer to a network infrastructure component that provides radio access for a remote terminal. In addition, depending upon the network type, other well-known terms such as “mobile station”, “user station”, “remote terminal”, “wireless terminal” or “user device” can be used to replace the “user equipment” or “UE”. For convenience, the terms “user equipment” and “UE” are used in this patent document to refer to a remote wireless device that wirelessly accesses to the gNB, no matter whether the UE is a mobile device (e.g., a mobile phone or a smart phone) or a generally-recognized immobile device (e.g., a desktop computer or a vending machine).

The gNB 102 provides wireless broadband access to a network 130 for a plurality of first UEs within a coverage region 120 of the gNB 102. The plurality of first UEs comprise: a UE 111, which can be located in a small enterprise (SB); a UE 112, which can be located in an enterprise (E); a UE 113, which can be located in a wireless fidelity (Wi-Fi) hotspot (HS); a UE 114, which can be located in a first residence (R); a UE 115, which can be located in a second residence (R); and, a UE 116, which can be a mobile device (M), for example, a cellular phone, a wireless laptop computer, a wireless PDA, etc. The gNB 103 provides wireless broadband access to the network 130 for a plurality of second UEs within a coverage region 125 of the gNB 103. The plurality of second UEs comprise a UE 115 and a UE 116. In some embodiments, one or more of gNBs 101 to 103 can communicate with each other and communicate with UEs 111 to 116 by using 5G, long term evolution (LTE), LTE-A, WiMAX or other advanced wireless communication technologies.

The dashed line shows the approximate range of the coverage regions 120 and 125, and this range is shown as being approximately circular only for the purpose of illustration and explanation. It should be clearly understood that the coverage region associated with the gNB (e.g., the coverage regions 120 and 125) can have other shapes, including irregular shapes, depending upon the configuration of the gNB and the change of the radio environment associated with natural obstacles and artificial obstacles.

As described in more detail below, one or more of the gNB 101, the gNB 102 and the gNB 103 comprises a 2D antenna array described in the embodiments of the disclosure. In some embodiments, one or more of the gNB 101, the gNB 102 and the gNB 103 supports the codebook design and structure for a system having a 2D antenna array.

Although FIG. 1 shows an example of the wireless network 100, various alterations can be made to FIG. 1. For example, the wireless network 100 can comprise any number of gNBs and any number of UEs in any suitable arrangement. Furthermore, the gNB 101 can directly communicate with any number of UEs, and provide wireless broadband access to the network 130 for these UEs. Similarly, each of the gNBs 102 to 103 can directly communicate with the network 130 and provide direct wireless broadband access to the network 130 for UEs. In addition, the gNB 101, 102 and/or 103 can provide access to other or additional external networks (e.g., external telephone networks or other types of data networks).

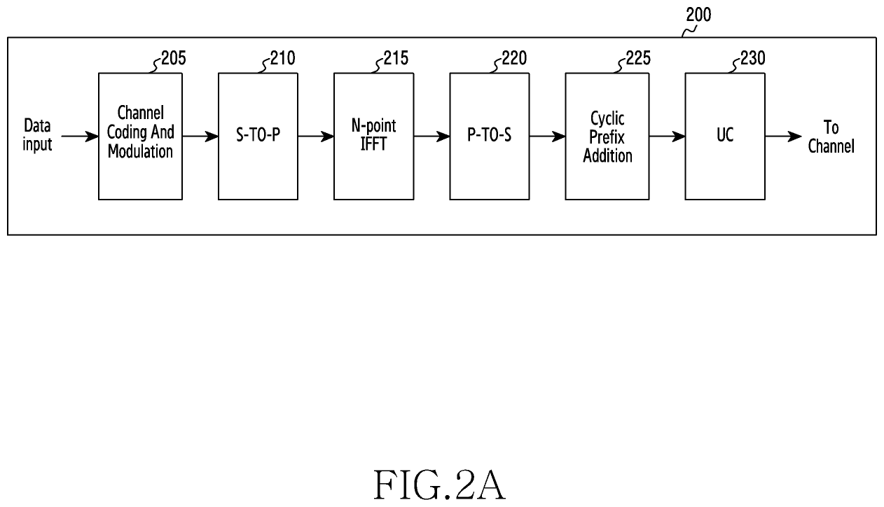

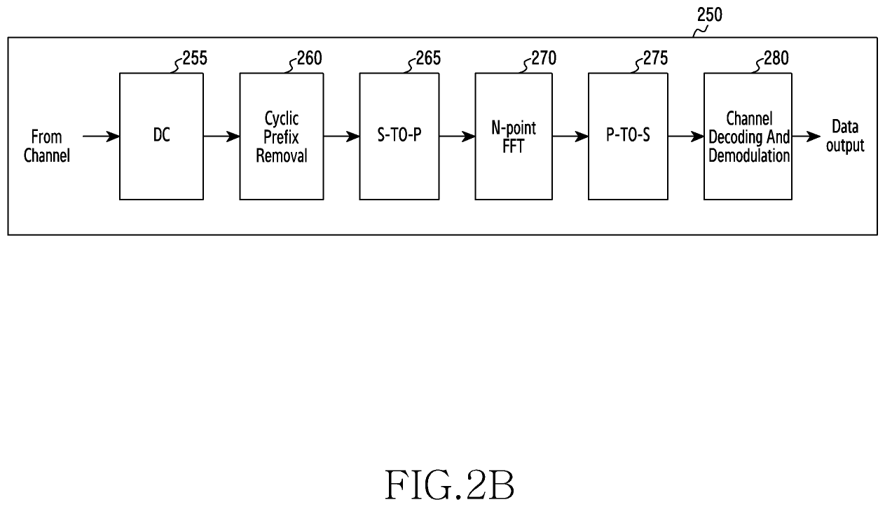

FIGS. 2A and 2B show various wireless transmitting and receiving paths according to the disclosure.

In the following description, the transmitting path 200 can be described as being implemented in a gNB (e.g., gNB 102), while the receiving path 250 can be described as being implemented in a UE (e.g., UE 116). However, it should be understood that the receiving path 250 can be implemented in a gNB while the transmitting path 200 can be implemented in a UE. In some embodiments, the receiving path 250 is configured to support the codebook design and structure for a system having the 2D antenna array described in the embodiments of the disclosure.

FIGS. 2A and 2B, the transmitting path 200 comprises a channel coding and modulation block 205, a serial-to-parallel (S-to-P) block 210, an N-point inverse fast Fourier transform (IFFT) block 215, a parallel-to-serial (P-to-S) block 220, a cyclic prefix addition block 225 and an up-converter (UC) 230. The receiving path 250 comprises a down-converter (DC) 255, a cyclic prefix removal block 260, a serial-to-parallel (S-to-P) block 265, an N-point fast Fourier transform (FFT) block 270, a parallel-to-serial (P-to-S) block 275 and a channel decoding and demodulation block 280.

In the transmitting path 200, the channel coding and modulation block 205 receives a set of information bits, and performs coding (e.g., low-density parity check (LDPC) coding) and modulation on input bits (e.g., by quadrature phase shift keying (QPSK) or quadrature amplitude modulation (QAM)) to generate a sequence of frequency domain modulation symbols. The serial-to-parallel (S-to-P) block 210 converts (e.g., de-multiplexes) a serial modulation symbol into parallel data to generate N parallel symbol streams, where N is the number of inverse fast Fourier transform/fast Fourier transform (IFFT/FFT) points used in the gNB 102 and the UE 116. The N-point IFFT block 215 performs an IFFT operation on the N parallel symbol streams to generate a time domain output signal. The parallel-to-serial block 220 converts (e.g., multiplexes) the parallel time domain output signal from the N-point IFFT block 215 to generate a serial time domain signal. The cyclic prefix addition block 225 interpolates a cyclic prefix into the time domain signal. The up-converter 230 modulates (e.g., up-converts) the output from the cyclic prefix addition block 225 to a radio frequency (RF) for transmission through a wireless channel Before being converted to the RF frequency, the signal can also be filtered at the baseband.

Referring to FIG. 2B, the RF signal transmitted from the gNB 102 reaches the UE 116 after passing through the wireless channel, and an operation opposite to the operation at the gNB 102 is executed at the UE 116. The down-converter 255 down-converts the received signal to a baseband frequency, and the cyclic prefix removal block 260 removes the cyclic prefix to generate a serial time domain baseband signal. The serial-to-parallel block 265 converts the time domain baseband signal into a parallel time domain signal. The N-point FFT block 270 executes an FFT algorithm to generate N parallel frequency domain signals. The parallel-to-serial block 275 converts the parallel frequency domain signals into a sequence of modulation data symbols. The channel decoding and demodulation block 280 performs demodulation and decoding on the modulation symbols to restore the original input data stream.

Each of the gNBs 101 to 103 can implement a transmitting path 200 similar to transmitting to UEs 111 to 116 in a downlink, and can implement a receiving path 250 similar to receiving from UEs 111 to 116 in an uplink. Similarly, each of the UEs 111 to 116 can implement a transmitting path 200 for transmitting to gNBs 101 to 103 in an uplink, and can implement a receiving path 250 for receiving from gNBs 101 to 103 in a downlink.

Each of the components in FIGS. 2A and 2B can be implemented by only software, or implemented by a combination of hardware and software/firmware. As a specific example, at least some of the components in FIGS. 2A and 2B can be implemented by software, while other components can be implemented by configurable hardware or a mixture of software and configurable hardware. For example, the FFT block 270 and the IFFT block 215 can be implemented as configurable software algorithms, wherein the value of the point number N can be altered according to implementations.

In addition, although the use of FFT and IFFT has been described, it is merely illustrative and it should not be interpreted as limiting the scope of the disclosure. Other types of transform can also be used, for example, discrete Fourier transform (DFT) and inverse discrete Fourier transform (IDFT) functions. It should be understood that, for DFT and IDFT functions, the value of the variable N may be any integer (e.g., 1, 2, 3, 4, etc.); while for FFT and IFFT functions, the value of the variable N may be any integer as the power of 2 (e.g., 1, 2, 4, 8, 16, etc.).

Although FIGS. 2A and 2B show the examples of the wireless transmitting and receiving paths, various alterations can be made to FIGS. 2A and 2B. For example, various components in FIGS. 2A and 2B can be combined, subdivided or omitted, and additional components can be added according to specific requirements. Moreover, FIGS. 2A and 2B are intended to show the examples of the types of transmitting and receiving paths that can be used in the wireless network. Any other suitable architecture can be used to support the wireless communication in the wireless network.

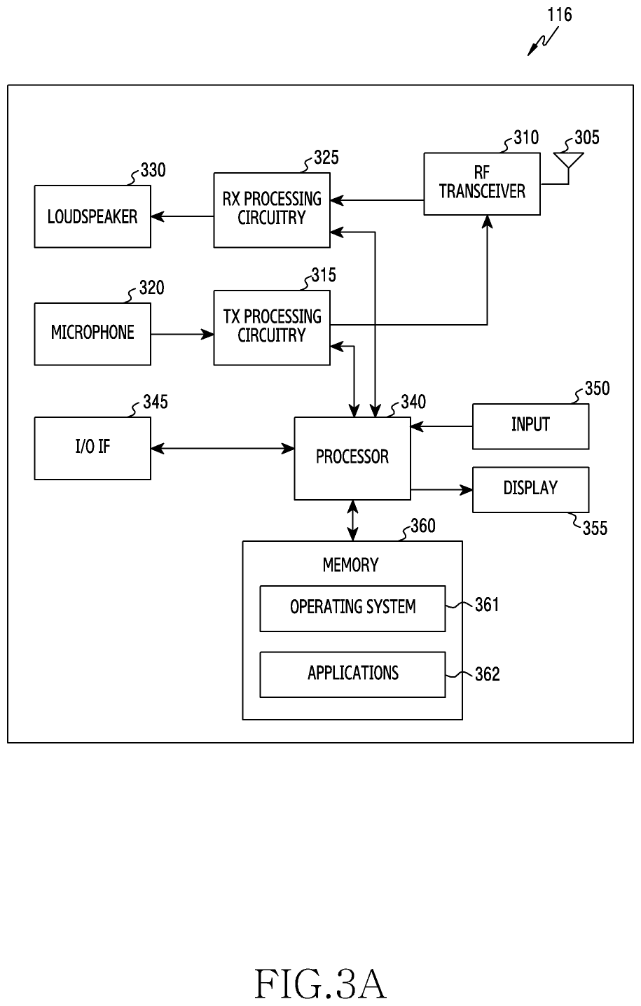

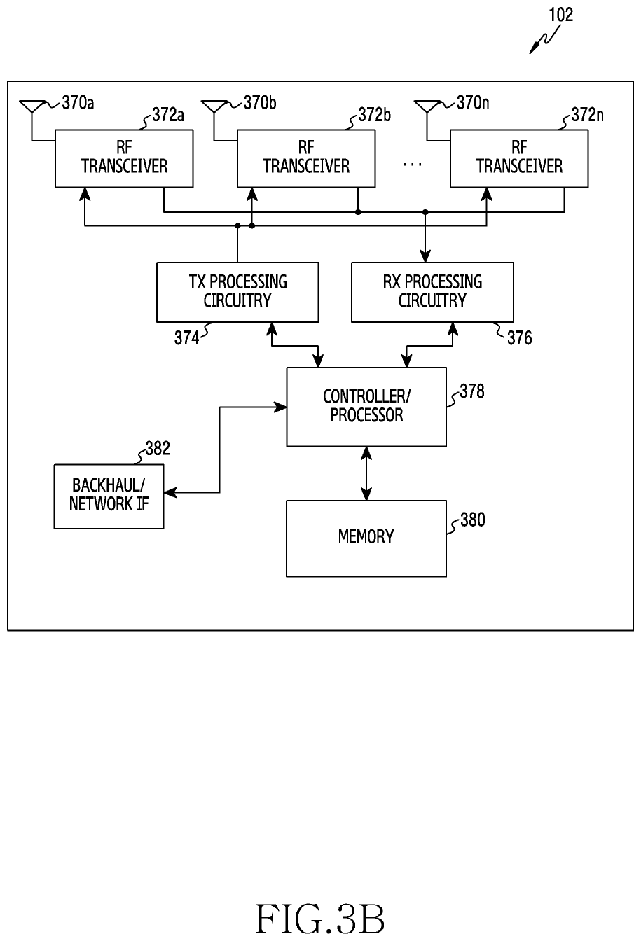

FIG. 3A shows an exemplary UE 116 according to the disclosure.

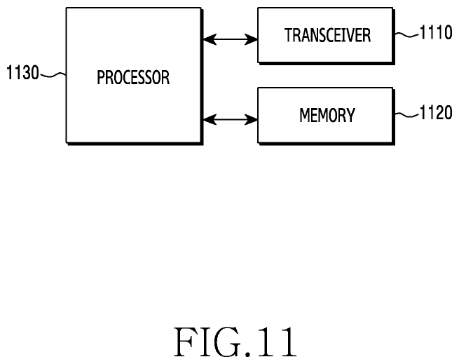

The embodiment of the UE 116 shown in FIG. 3A is merely for the purpose of illustration, and the UEs 111 to 115 in FIG. 1 can have the same or similar configuration. However, the UE has various configurations, and FIG. 3A does not limit the scope of the disclosure to any specific implementation of the UE. For example, the UE 116 may include more or fewer components than those described above. In addition, the UE 116 corresponds to the UE of the FIG. 11.

The UE 116 comprises an antenna 305, a radio frequency (RF) transceiver 310, a transmitting (TX) processing circuit 315, a microphone 320 and a receiving (RX) processing circuit 325. The UE 116 further comprises a loudspeaker 330, a processor/controller 340, an input/output (I/O) interface (IF) 345, an input device(s) 350, a display 355 and a memory 360. The memory 360 comprises an operating system (OS) 361 and one or more applications 362.

The RF transceiver 310 receives, from the antenna 305, an incoming RF signal transmitted by the gNB in the wireless network 100. The RF transceiver 310 down-converts the incoming RF signal to generate an intermediate-frequency (IF) or baseband signal. The IF or baseband signal is transmitted to the RX processing circuit 325, and the RX processing circuit 325 performs filtering, decoding and/or digitization on the baseband or IF signal to generate the processed baseband signal. The RX processing circuit 325 transmits the processed baseband signal to the loudspeaker 330 (e.g., for voice data) or to the processor/controller 340 (e.g., for network browsing data) for further processing.

The TX processing circuit 315 receives the analog or digital voice data from the microphone 320 or receives other outgoing baseband data (e.g., network data, e-mail or interactive video game data) from the processor/controller 340. The TX processing circuit 315 performs encoding, multiplexing and/or digitization on the outgoing baseband data to generate the processed baseband or IF signal. The RF transceiver 310 receives the processed outgoing baseband or IF signal from the TX processing circuit 315, and up-converts the baseband or IF signal into the RF signal transmitted by the antenna 305.

The processor/controller 340 can comprise one or more processors or other processing devices, and execute the OS 361 stored in the memory 360 so as to control the overall operation of the UE 116. For example, the processor/controller 340 can control the reception of forward channel signals and the transmission of backward channel signals through the RF transceiver 310, the RX processing circuit 325 and the TX processing circuit 315 according to the well-known principles. In some embodiments, the processor/controller 340 comprises at least one microprocessor or microcontroller.

The processor/controller 340 can also execute other processes and programs residing in the memory 360, for example, channel quality measurement and reporting operations for a system having the 2D antenna array described in the embodiments of the disclosure. The processor/controller 340 can migrate data into or out of the memory 360 according to the requirements of the execution process. In some embodiments, the processor/controller 340 is configured to execute the application 362 on the basis of the OS 361 or in response to the signal received from the gNB or the operator. The processor/controller 340 is also coupled to the I/O interface 345, and the I/O interface 345 provides the UE 116 with the ability to be connected to other devices such as laptop computers and handheld computers. The I/O interface 345 is a communication path between these accessories and the processor/controller 340.

The processor/controller 340 is also coupled to the input device(s) 350 and the display 355. The operator of the UE 116 can use the input device(s) 350 to input data into the UE 116. The display 355 can be a liquid crystal display or other displays capable of presenting text and/or at least finite graphics (e.g., from a website). The memory 360 is coupled to the processor/controller 340. A part of the memory 360 can comprise a random access memory (RAM), while the other part of the memory 360 can comprise a flash memory or other read only memories (ROMs).

Although FIG. 3A shows an example of the UE 116, various alterations can be made to FIG. 3A. For example, various components in FIG. 3A can be combined, subdivided or omitted, and additional components can be added according to specific requirements. As a specific example, the processor/controller 340 can be divided into a plurality of processors, for example, one or more central processing units (CPUs) and one or more graphic processing units (GPUs). Moreover, although FIG. 3A shows the UE 116 configured as a mobile phone or a smart phone, the UE can be configured to be operated as other types of mobile or immobile devices.

FIG. 3B shows an exemplary gNB 102 according to the disclosure.

The embodiment of the gNB 102 referring to FIG. 3B is merely for the purpose of illustration, and other gNBs in FIG. 1 can have the same or similar configuration. However, the gNB has various configurations, and FIG. 3B does not limit the scope of the disclosure to any specific implementation of the gNB. It is to be noted that the gNB 101 and the gNB 103 can comprise a structure the same as or similar to that of the gNB 102.

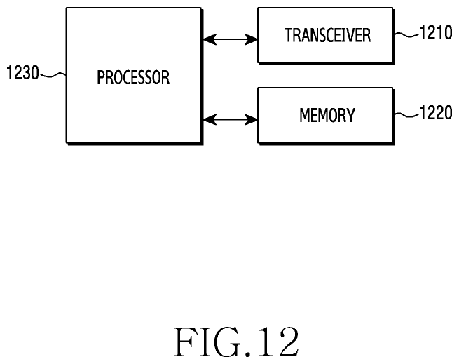

Referring to FIG. 3B, the gNB 102 comprises a plurality of antennas 370a to 370n, a plurality of RF transceivers 372a to 372n, a TX processing circuit 374 and an RX processing circuit 376. In some embodiments, one or more of the plurality of antennas 370a to 370n comprise a 2D antenna array. The gNB 102 further comprises a controller/processor 378, a memory 380 and a backhaul or network interface 382. However, the components of the gNB 102 are not limited thereto. For example, the gNB 102 may include more or fewer components than those described above. In addition, the gNB 102 corresponds to the base station of the FIG. 12.

The RF transceivers 372a to 372n receive incoming RF signals from the antennas 370a to 370n, for example, signals transmitted by the UE or other gNBs. The RF transceivers 372a to 372n down-convert the incoming RF signals to generate IF or baseband signals. The IF or baseband signals are transmitted to the RX processing circuit 376, and the RX processing circuit 376 performs filtering, decoding and/or digitization on the baseband or IF signals to generate the processed baseband signals. The RX processing circuit 376 transmits the processed baseband signals to the controller/processor 378 for further processing.

The TX processing circuit 374 receives analog or digital data (e.g., voice data, network data, e-mail or interactive video game data) from the controller/processor 378. The TX processing circuit 374 performs encoding, multiplexing and/or digitization on the outgoing baseband data to generate the processed baseband or IF signals. The RF transceivers 372a to 372n receive the processed outgoing baseband or IF signals from the TX processing circuit 374, and up-convert the baseband or IF signals into the RF signals transmitted by the antennas 370a to 370n.

The controller/processor 378 can comprise one or more processors or other processing devices for controlling the overall operation of the gNB 102. For example, the processor/controller 378 can control the reception of forward channel signals and the transmission of backward channel signals through the RF transceivers 372a to 372n, the RX processing circuit 376 and the TX processing circuit 374 according to the well-known principles. The controller/processor 378 can also support additional functions, such as more advanced wireless communication functions. For example, the controller/processor 378 can execute a BIS process, for example, by a blind interference sensing (BIS) algorithm, and decode the received signal from the interference signal is removed. The controller/processor 378 can support, in the gNB 102, any one of various other functions. In some embodiments, the controller/processor 378 comprises at least one microprocessor or microcontroller.

The controller/processor 378 can also execute programs and other processes (e.g., the basic OS) residing in the memory 308. The controller/processor 378 can also support channel quality measurement and reporting for a system having the 2D antenna array described in the embodiments of the disclosure. In some embodiments, the controller/processor 378 supports the communication between entities such as web RTCs. The controller/processor 378 can migrate data into or” out’ f the memory 380 according to the requirements of the execution process.

The controller/processor 378 is also coupled to the backhaul or network interface 382. The backhaul or network interface 382 allows the gNB 102 to communicate with other devices or systems through a backhaul connection or a network. The backhaul or network interface 382 can support communication through any suitable wired or wireless connection(s). For example, when the gNB 102 is implemented as a part of a cellular communication system (e.g., a cellular communication system supporting 5G or new radio access technology or NR, LTE or LTE-A), the backhaul or network interface 382 can allow the gNB 102 to communicate with other gNBs through a wired or wireless backhaul connection. When the gNB 102 is implemented as an access point, the backhaul or network interface 382 can allow the gNB 102 to communicate with a larger network (e.g., Internet) through a wired or wireless local area network or through a wired or wireless connection. The backhaul or network interface 382 comprises any suitable structure that supports communication through a wired or wireless connection, e.g., the Ethernet or an RF transceiver.

The memory 380 is coupled to the controller/processor 378. A part of the memory 380 can comprise a RAM, while the other part of the memory 380 can comprise a flash memory or other ROMs. In some embodiments, a plurality of instructions such as the BIS algorithm are stored in the memory. The plurality of instructions are configured to cause the controller/processor 378 to execute the BIS process and decode the received signal after at least one interference signal determined by the BIS algorithm is removed.

As described in more detail below, the transmitting and receiving paths of the gNB 102 (implemented by using the RF transceivers 372a to 372n, the TX processing circuit 374 and/or the RX processing circuit 376) support aggregated communication with FDD cells and TDD cells.

Although FIG. 3B shows an example of the gNB 102, various alterations can be made to FIG. 3B. For example, the gNB 102 can comprise any number of each component shown in FIG. 3A. As a specific example, the access point can comprise many backhaul or network interfaces 382, and the controller/processor 378 can support a routing function to route data between different network addresses. As another specific example, although it is shown that the gNB comprises a single instance of the TX processing circuit 374 and a single instance of the RX processing circuit 376, the gNB 102 can comprise a plurality of instances of each of the TX processing circuit and the RX processing circuit (for example, each RF transceiver corresponds to one instance).

It should be understood that the solutions provided in the embodiments of the disclosure can be applied to, but not limited, the above wireless network.

Exemplary embodiments of the disclosure will be further described below with reference to the accompanying drawings.

The text and the accompanying drawings are merely provided as examples to help readers to understand the disclosure. They are not intended to limit the scope of the disclosure in any way. Although some embodiments and examples have been provided, based on the contents disclosed herein, it is obvious to those skilled in the art that the illustrated embodiments and examples can be altered without departing from the scope of the disclosure.

The transmission from a base station to a user equipment (UE) is called downlink, and the transmission from a UE to a base station is called uplink. The hybrid automatic repeat request acknowledgement (HARQ-ACK) information of a physical downlink shared channel (PDSCH) can be transmitted on a physical uplink shared channel (PUSCH) or a physical uplink control channel (PUCCH), and the PDSCH is scheduled by downlink control information transmitted by a physical downlink control channel (PDCCH).

The unicast PDSCH is a PDSCH received by one UE, and the PDSCH is scrambled on the basis of a radio network temporary indicator (RNTI) specific to the UE, for example, namely cell RNTI (C-RNTI), while the groupcast or multicast/broadcast is a PDSCH received by a plurality of UEs.

In order to better satisfy the actual application requirements, it is necessary to provide a technology for transmitting HARQ-ACK of a groupcast or multicast/broadcast PDSCH.

The technical solutions of the disclosure and how to solve the above technical problems by the technical solutions of the disclosure will be described below in detail by specific embodiments. The following specific embodiments can be combined with each other, and the same or similar concepts or processes may not be repeated in some embodiments. The embodiments of the disclosure will be described below with reference to the accompanying drawings. The text and the accompanying drawings in the following description are merely provided as examples to help readers to understand the disclosure. They are not intended to limit the scope of the disclosure in any way. Although some embodiments and examples have been provided, based on the contents disclosed herein, it is obvious to those skilled in the art that the illustrated embodiments and examples can be altered without departing from the scope of the disclosure.

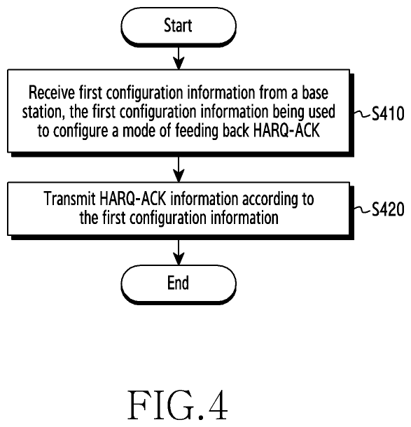

FIG. 4 shows a flowchart of an exemplary method 400 according to an embodiment of the disclosure.

The exemplary method 400 of FIG. 4 can be used to transmit HARQ-ACK information. This method 400 can be implemented on the UE side.

Referring to FIG. 4, the method 400 comprises the following steps.

At operation S410, First configuration information is received from a base station, the first configuration information being used to configure a mode of feeding back HARQ-ACK information.

The first configuration information may be information configured through a high-layer signaling or a medium access layer signaling, and the first configuration information configures the mode of feeding back HARQ-ACK information.

At operation S420, HARQ-ACK information is transmitted to base station on the basis of the first configuration information.

In a case, the mode of feeding back HARQ-ACK information comprises at least one of the following: feeding back HARQ-ACK information; not feeding back HARQ-ACK information; and, feeding back HARQ-ACK information or not according to indication information. The indication information may be information in DCI in a PDCCH for scheduling a PDSCH.

In some embodiments, before operation S420, the method may comprise the following.

After the mode of feeding back HARQ-ACK is determined on the basis of the first configuration information, the number of bits of the HARQ-ACK information may be determined on the basis of the determined mode of feeding back HARQ-ACK information.

After the number of bits of the HARQ-ACK information is determined, the HARQ-ACK information may be determined on the basis of the determined number of bits of the HARQ-ACK information. This process may be implemented by the existing related technology, and will not be repeated here for simplicity of description.

Optionally, if the mode of feeding back HARQ-ACK information is feeding back HARQ-ACK information or not according to the indication information, before operation S420, the method may further comprise:

receiving a downlink assignment index (DAI);

determining the number of bits of HARQ-ACK information; and

generating the HARQ-ACK information according to the number of bits of HARQ-ACK information.

That is, in this embodiment, the number of bits of the HARQ-ACK information may be determined on the basis of the DAI in the DCI.

Optionally, a counting mode for the DAI is one of the following:

a first counting mode is counting scheduled PDSCHs and PDCCHs indicating semi-persistent scheduling (SPS) PDSCH release that are indicated as HARQ-ACK information to be fed back by the indication information;

a second counting mode is counting scheduled PDSCHs and PDCCHs indicating SPS PDSCH release that are indicated as HARQ-ACK information to be fed back by the indication information, and scheduled PDSCHs and PDCCHs indicating SPS PDSCH release that are indicated as HARQ-ACK information to be not fed back by the indication information; and

a third counting mode is determining, according to second configuration information from the base station, to perform counting in the first counting mode or the second counting mode.

The second configuration information may be configured by the base station through a high-layer signaling.

That is, in this embodiment, the counting mode for the DAI may be specific to only scheduled PDSCHs and PDCCHs indicating SPS PDSCH release that are indicated as HARQ-ACK information to be fed back by the indication information; or, the counting mode may be specific to scheduled PDSCHs and PDCCHs indicating SPS PDSCH release that are indicated as HARQ-ACK information to be fed back by the indication information, and scheduled PDSCHs and PDCCHs indicating SPS PDSCH release that are indicated as HARQ-ACK information to be not fed back by the indication information; or, the counting mode for the DAI may be determined as one of the two counting modes on the basis of configuration information configured through high-layer information. On this basis, the number of bits of the HARQ-ACK information is determined.

In some embodiments, the determining the number of bits of HARQ-ACK information comprises at least one of the following:

a first mode is calculating the HARQ-ACK information of PDSCHs or PDCCHs indicating SPS PDSCH release that are indicated as HARQ-ACK information to be fed back by the indication information, among the PDSCHs or PDCCHs indicating SPS PDSCH release received by the UE;

a second mode is calculating the HARQ-ACK information of all PDSCHs or PDCCHs indicating SPS PDSCH release if the HARQ-ACK information of at least one PDSCH or PDCCH indicating SPS PDSCH release, among the PDSCHs or PDCCHs indicating SPS PDSCH release received by the UE, is indicated as HARQ-ACK information to be fed back by the indication information;

a third mode is calculating the HARQ-ACK information of the last PDSCH or PDCCH indicating SPS PDSCH release that is indicated as HARQ-ACK information to be fed back by the indication information and the HARQ-ACK information of all previous PDSCH or PDCCHs indicating SPS PDSCH, among the PDSCHs or PDCCHs indicating SPS PDSCH release received by the UE;

a fourth mode is calculating the HARQ-ACK information of all received PDSCHs or PDCCHs indicating SPS PDSCH release if the HARQ-ACK information of the last PDSCH or PDCCH indicating SPS PDSCH release received by the UE is indicated as HARQ-ACK to be fed back by the indication information; and

a fifth mode is determining, according to third configuration information, to perform calculation in one of the first mode, the second mode, the third mode and the fourth mode.

The third configuration information may be configured by the base station through a high-layer signaling.

In another case, the mode of feeding back HARQ-ACK by the UE comprises one of a first feedback mode and a second feedback mode, wherein the first feedback mode is a negative acknowledgement (NACK)-only mode, and the second feedback mode is an ACK/NACK mode.

Specifically, the first feedback mode may also be a first mode of feeding back HARQ-ACK by the UE, and the second feedback mode may also be a second mode of feeding back HARQ-ACK by the UE, wherein:

The first mode is as follows: the UE does not feed back HARQ-ACK information if the UE correctly decodes the PDSCH, and the UE feeds back NACK on a PUCCH resource if the UE receives the PDCCH but does not correctly decode the PDSCH. This mode of feeding back HARQ-ACK by the UE is called a NACK-only mode.

The second mode is as follows: the UE feed backs ACK on a PUCCH resource if the UE correctly decodes the PDSCH, and the UE feeds back NACK on a PUCCH resource if the UE receives the PDCCH but does not correctly decode the PDSCH. This mode of feeding back HARQ-ACK by the UE is called an ACK/NACK mode.

In one embodiment, if the mode of feeding back HARQ-ACK by the UE is the first feedback mode, before operation S420, the method may further comprise:

determining HARQ-ACK information to be fed back.

In some embodiments, if the UE is configured with a type-1 HARQ-ACK codebook, the determining HARQ-ACK to be fed back may specifically comprise any one of the following:

if the UE receives activated semi-static SPS PDSCHs or PDCCHs indicating SPS PDSCH release, determining that the UE feeds back the HARQ-ACK information of the activated SPS PDSCHs or the HARQ-ACK information of the PDCCHs indicating SPS PDSCH release;

if the UE receives activated semi-static SPS PDSCHs or PDCCHs indicating SPS PDSCH release, determining that the UE feeds back the HARQ-ACK information of the activated SPS PDSCHs or the HARQ-ACK information of the PDCCHs indicating SPS PDSCH release, the number of bits of the HARQ-ACK information to be fed back by the UE being determined according to the type-1 HARQ-ACK codebook;

if the UE receives activated SPS PDCCHs and other PDSCHs or PDSCHs indicating SPS PDSCH release and other PDSCHs, determining that the UE feeds back the HARQ-ACK information of the activated SPS PDSCHs or the HARQ-ACK information of the PDCCHs indicating SPS PDSCH release but does not feed back the HARQ-ACK information of the other PDSCHs; and

if the UE receives activated SPS PDSCHs and other PDSCHs or PDCCHs indicating SPS PDSCH release and other PDSCHs, determining that the UE feeds back the HARQ-ACK information of the activated SPS PDSCHs and the HARQ-ACK information of the other PDSCHs in the second feedback mode or feeds back the HARQ-ACK information of the PDCCH indicating SPS PDSCH release and the HARQ-ACK information of the other PDSCHs in the second feedback mode.

Specifically, in this embodiment, the type-1 HARQ-ACK codebook is a semi-static HARQ-ACK codebook.

In other embodiments, if the UE is configured with a type-2 HARQ-ACK codebook, the determining HARQ-ACK to be fed back may specifically comprise any one of the following:

if the UE receives activated SPS PDCCHs and other PDSCHs or PDSCHs indicating SPS PDSCH release and other PDSCHs, determining to feed back the HARQ-ACK information of the activated SPS PDSCHs or the HARQ-ACK information of the PDCCHs indicating SPS PDSCH release, and determining to not feed back the HARQ-ACK information of the other PDSCHs;

if the UE receives activated SPS PDSCHs and other PDSCHs or PDCCHs indicating SPS PDSCH release and other PDSCHs, determining to feed back the HARQ-ACK information of the activated SPS PDSCHs and the HARQ-ACK information of the other PDSCHs in the second feedback mode, or determining to feed back the HARQ-ACK information of the PDCCH indicating SPS PDSCH release and the HARQ-ACK information of the other PDSCHs in the second feedback mode; and

not expecting the UE to receive, on one uplink resource, information of the activated SPS PDSCHs and other PDSCHs or information of the PUCCHs indicating SPS PDSCH release and other PDSCHs.

Specifically, in this embodiment, the type-2 HARQ-ACK codebook is a dynamic HARQ-ACK codebook.

In other embodiments, the PDSCHs received by the UE comprises a first type of PDSCHs and a second type of PDSCHs; and, if the mode of feeding back HARQ-ACK by the UE is the first feedback mode, the UE is configured with a first uplink resource for transmitting HARQ-ACK information and a second uplink resource for transmitting HARQ-ACK information of the first type of PDSCHs.

The method 400 further comprises any one of the following steps:

if the UE feeds back HARQ-ACK information in the first feedback mode, transmitting the HARQ-ACK information by using the first uplink resource;

or,

if the UE transmits the HARQ-ACK information of the first type of PDSCHs, transmitting the HARQ-ACK information by using the second uplink resource;

or,

if the UE transmits the HARQ-ACK information of the activated SPS PDSCHs or the HARQ-ACK information of the PDCCHs indicating SPS PDSCH release, transmitting the HARQ-ACK information by using the second uplink resource or a third uplink resource,

wherein the third uplink resource is an uplink resource configured to transmit the HARQ-ACK information of the activated SPS PDSCHs or the HARQ-ACK information of the PDCCHs indicating SPS PDSCH release;

or,

if the UE transmits the HARQ-ACK information of the activated SPS PDSCHs and the HARQ-ACK information of the other PDSCHs or if the UE transmits the HARQ-ACK information of the PDCCHs indicating SPS PDSCH release and the HARQ-ACK information of the other PDSCHs, transmitting the HARQ-ACK information by using the second uplink resource or the third uplink resource.

In one optional embodiment, the transmitting the HARQ-ACK information by using the second uplink resource or the third uplink resource comprises:

if the UE is configured with the third uplink resource, transmitting the HARQ-ACK information by using the third uplink resource; and

if the UE is not configured with the third uplink resource, transmitting the HARQ-ACK information by using the second uplink resource.

An embodiment of the disclosure further provides a method for transmitting hybrid automatic repeat request acknowledgement (HARQ-ACK) information. The method may be executed by a base station. The method comprises steps of:

transmitting first configuration information to a user equipment (UE), the first configuration information being used to configure a mode of feeding back HARQ-ACK information; and

receiving HARQ-ACK information according to the first configuration information.

In this embodiment, the first configuration information may be transmitted through a high-layer signaling or a medium access layer signaling.

In some embodiments, the mode of feeding back HARQ-ACK information comprises at least one of the following:

feeding back HARQ-ACK information;

not feeding back HARQ-ACK information; and

feeding back HARQ-ACK information or not according to indication information.

In other embodiments, if the mode of feeding back HARQ-ACK information is feeding back HARQ-ACK information or not according to indication information, before receiving HARQ-ACK information, the method further comprises:

transmitting a downlink assignment index (DAI) to the UE, a counting mode for the DAI being one of the following:

a first counting mode is counting scheduled PDSCHs and PDCCHs indicating SPS PDSCH release that are indicated as HARQ-ACK information to be fed back by the indication information;

a second counting mode is counting scheduled PDSCHs and PDCCHs indicating SPS PDSCH release that are indicated as HARQ-ACK information to be fed back by the indication information, and scheduled PDSCHs and PDCCHs indicating SPS PDSCH release that are indicated as HARQ-ACK information to be not fed back by the indication information; and

a third counting mode is determining, according to second configuration information from the base station, to perform counting in the first counting mode or the second counting mode.

The technical solutions in the embodiments of the disclosure will be described below by taking transmitting, on a PUCCH, HARQ-ACK information of a PDSCH as an example. However, it should be understood by those skilled in the art that, the HARQ-ACK information of the PDSCH may be transmitted on a PUSCH or the HARQ-ACK information of the PDSCH may be transmitted on a physical random access channel (PRACH), and the solutions described below by taking a PUCCH as an example are also applied to PUSCHs and PRACHs.

In an example, the UE does not feed back HARQ-ACK, that is, the UE neither feed back ACK nor HACK.

The distances between UEs receiving PDSCHs and the base station are different. The signals received by UEs far from the base station are poor in quality, the signals received by UEs near the base station are good in quality, and the signals received by UEs just far enough from the base station are moderate in quality. Multicast PDSCHS adopts a certain coding and modulation code, and PDCCHs for scheduling multicast PDSCHs adopt a certain aggregation level (AL).

At this time, the signals received by UEs near the base station are good in quality, so the error probability of PDCCH detection and PDSCH decoding is extremely low, and such UEs may be configured to not feed back HARQ-ACK through a high-layer signaling (not feeding back HARQ-ACK may also be called HARQ-ACK disabling); the signals received by UEs far from the base station are poor in quality, so there a certain error probability of PDCCH detection and PDSCH decoding, and such UEs may be configured to feed back HARQ-ACK through a high-layer signaling (feeding back HARQ-ACK may also be called HARQ-ACK enabling); and, the signals received by UEs just far enough from the base station are moderate in quality, so the error probability of PDCCH detection is very low, there is a certain error probability of PDSCH decoding, and such UEs may be configured to feed back HARQ-ACK or not by receiving physical layer signaling indication.

That is, among a plurality of UEs that receive a same multicast PDSCH, some UEs are configured to not feed back HARQ-ACK through a high-layer signaling, while some UEs are configured to feed back HARQ-ACK through a high-layer signaling. Whether the two types of UEs feeding back HARQ-ACK or not is indicated and determined by the information in DCI, while whether some UEs feeding back HARQ-ACK or not is indicated and determined by the information in DCI.

The specific process of determining the bits of HARQ-ACK information “when a UE will feed back, on a PUCCH, HARQ-ACK information of at least one PDSCH or PDCCH indicating SPS PDSCH release” will be described in detail below by embodiments.

### Embodiment 1

For the HARQ-ACK information of each of a plurality of PDSCHs received by a UE, different UEs may transmit the HARQ-ACK information in different modes of feeding back HARQ-ACK by the UE.

### Example 1-1

A downlink assignment index (DAI) (the DAI may comprise a Counter-DAI (denoted by C-DAI) and a Total-DAI (denoted by T-DAI)) field is added in the DCI for scheduling a PDSCH, wherein the C-DAI is used to indicate the numbers of scheduled PDSCHs and PDCCHs indicating SPS PDSCH release until the currently received PDCCH, and the T-DAI is used to indicate the number of scheduled PDSCHs and PDCCHs indicating SPS PDSCH release until the PDCCH monitoring occasion where the currently received PDCCH is located. The following description will be given by taking the C-DAI as an example, and the T-DAI may also be counted in a similar way.

When the configured mode of feeding back HARQ-ACK by a UE is determining according to indication information whether the UE feeds back HARQ-ACK, the counting method for the DAI comprises the following three methods.

Method 1:

The count of the DAI only comprises scheduled PDSCHs and PDCCHs indicating SPS PDSCH release that are indicated as HARQ-ACK to be fed back by the indication information, and the count of the DAI does not comprise scheduled PDSCHs and PDCCHs indicating SPS PDSCH release that are indicated as HARQ-ACK to be not fed back by the indication information.

That is, the scheduled PDSCHs and PDCCHs indicating SPS PDSCH release that are indicated as HARQ-ACK to be fed back by the indication information are counted, and the scheduled PDSCHs and PDCCHs indicating SPS PDSCH release that are indicated as HARQ-ACK to be not fed back by the indication information are not counted.

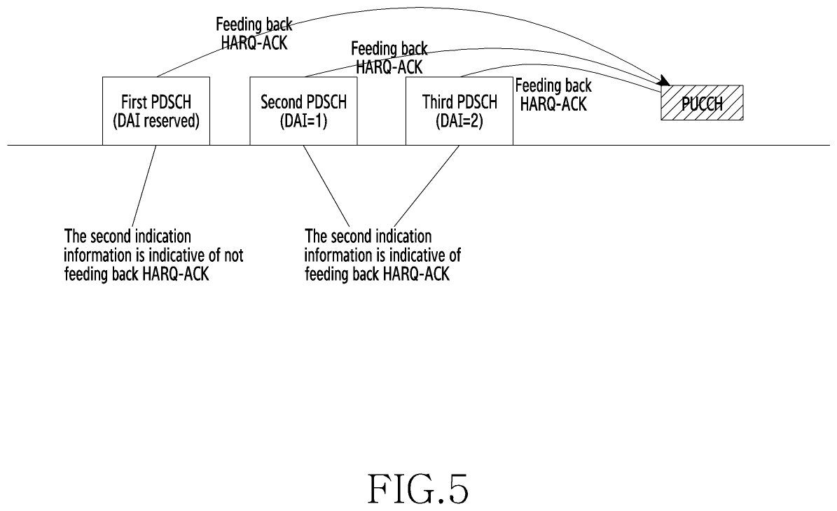

FIG. 5 shows a schematic diagram of a specific example of transmitting HARQ-ACK information according to an embodiment of the disclosure.

Referring to FIG. 5, the UE receives a first PDSCH, the indication information in the DCI of a PDCCH for scheduling this PDSCH is indicative of not feeding back HARQ-ACK, and the DAI bit in the DCI is a reserved bit. The UE receives a second PDSCH, the indication information in the DCI of a PDCCH for scheduling this PDSCH is indicative of feeding back HARQ-ACK, and the DAI in the DCI is equal to 1. The UE receives a third PDSCH, the indication information in the DCI of a PDCCH for scheduling this PDSCH is indicative of feeding back HARQ-ACK, and the DAI in the DCI is equal to 2. That is, the PDCCHs for scheduling the second PDSCH and the third PDSCH are counted.

This method has the following advantages: the transmission of meaningless HARQ-ACK information can be avoided, and the number of bits of the transmitted HARQ-ACK information can be decreased.

Method 2:

The count of the DAI comprises scheduled PDSCHs and PDCCHs indicating SPS PDSCH release that are indicated as HARQ-ACK to be fed back by the indication information, and scheduled PDSCHs and PDCCHs indicating SPS PDSCH release that are indicated as HARQ-ACK to be not fed back by the indication information.

That is, the scheduled PDSCHs and PDCCHs indicating SPS PDSCH release that are indicated as HARQ-ACK to be fed back by the indication information and the scheduled PDSCHs and PDCCHs indicating SPS PDSCH release that are indicated as HARQ-ACK to be not fed back by the indication information are counted.

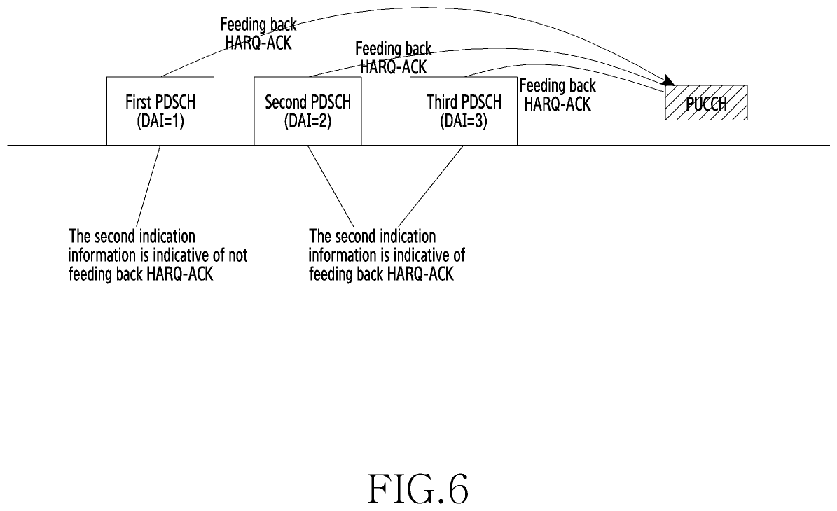

FIG. 6 shows a schematic diagram of an example of transmitting HARQ-ACK information according to an embodiment of the disclosure.

Referring to FIG. 6, the UE receives a first PDSCH, the indication information in the DCI of a PDCCH for scheduling this PDSCH is indicative of not feeding back HARQ-ACK, and the DAI in the DCI is equal to 1. The UE receives a second PDSCH, the indication information in the DCI of a PDCCH for scheduling this PDSCH is indicative of feeding back HARQ-ACK, and the DAI in the DCI is equal to 2. The UE receives a third PDSCH, the indication information in the DCI of a PDCCH for scheduling this PDSCH is indicative of feeding back HARQ-ACK, and the DAI in the DCI is equal to 3. That is, the PDCCHs for scheduling the first PDSCH, the second PDSCH and the third PDSCH are counted.

This method has the following advantages: when the mode of feeding back HARQ-ACK by some UEs among UEs that receive a same PDSCH is feeding back HARQ-ACK and the mode of feeding back HARQ-ACK by some UEs is determining according to the indication information whether UEs feed back HARQ-ACK, it can be avoided that different UEs have different understandings of DAI counting.

Method 3:

The UE determines to count the DAI by the method 1 or method 2 by receiving configuration information (e.g., high-layer signaling configuration)

This method has the following advantages: when the mode of feeding back HARQ-ACK by some UEs among UEs that receive a same PDSCH is feeding back HARQ-ACK and the mode of feeding back HARQ-ACK by some UEs is determining according to the indication information whether the UEs feed back HARQ-ACK, the UE determines to count the DAI by the method 2 by receiving the information configuration (e.g., high-layer signaling configuration), and it can be avoided that different UEs have different understandings of DAI counting. When different UEs will not have different understandings of DAI counting, the transmission of meaningless HARQ-ACK information can be avoided, and the number of bits of the transmitted HARQ-ACK information can be decreased.

### Example 1-2

When the configured mode of feeding back HARQ-ACK information by a UE is determining according to indication information whether the UE feeds back HARQ-ACK information, the method for calculating the number of bits of the HARQ-ACK information comprises the following methods.

Method 1:

When a UE will feed back, on a PUCCH, HARQ-ACK information of at least one PDSCH or PDCCH indicating SPS PDSCH release and when the HARQ-ACK information of at least one PDSCH or PDCCH indicating SPS PDSCH release is indicated as HARQ-ACK to be fed back by the indication information, the HARQ-ACK information of all PDSCHs or PDCCHs indicating SPS PDSCH release is HARQ-ACK to be fed back; and, when the HARQ-ACK information of all PDSCHs or PDCCHs indicating SPS PDSCH release is indicated as HARQ-ACK to be not fed back by the indication information, the HARQ-ACK information of all PDSCHs or PDCCHs indicating SPS PDSCH release is HARQ-ACK to be not fed back.

That is, in a case where a UE will feed back, on a PUCCH, HARQ-ACK information of more than one PDSCH or PDCCH indicating SPS PDSCH release, if the HARQ-ACK information of at least one PDSCH or PDCCH indicating SPS PDSCH release is indicated as HARQ-ACK to be fed back by the indication information, all PDSCHs or PDCCHs indicating SPS PDSCH release are taken into consideration during the calculation of the number of bits of the HARQ-ACK information; and, if the HARQ-ACK information of all PDSCHs or PDCCHs indicating SPS PDSCH release is indicated as HARQ-ACK to be not fed back by the indication information, all PDSCHs or PDCCHs indicating SPS PDSCH release are not taken into consideration during the calculation of the number of bits of the HARQ-ACK information.

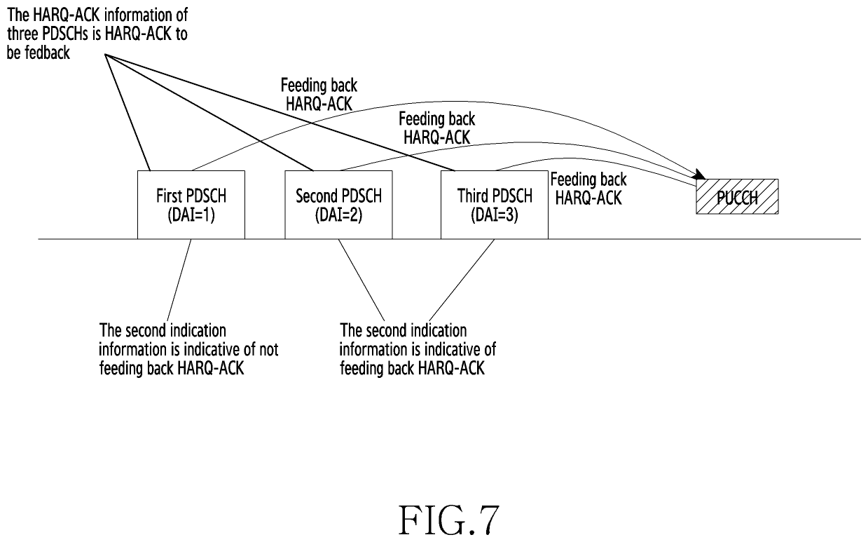

FIG. 7 shows a schematic diagram of another example of transmitting HARQ-ACK information according to an embodiment of the disclosure.

Referring to FIG. 7, the UE receives a first PDSCH, the indication information in the DCI of a PDCCH for scheduling this PDSCH is indicative of not feeding back HARQ-ACK, and the DAI in the DCI is equal to 1. The UE receives a second PDSCH, the indication information in the DCI of a PDCCH for scheduling this PDSCH is indicative of feeding back HARQ-ACK, and the DAI in the DCI is equal to 2. The UE receives a third PDSCH, the indication information in the DCI of a PDCCH for scheduling this PDSCH is indicative of feeding back HARQ-ACK, and the DAI in the DCI is equal to 3. At this time, during the calculation of the number of bits of the HARQ-ACK information, the HARQ-ACK information of the first PDSCH, the second PDSCH and the third PDSCH is considered as HARQ-ACK to be fed back.

The UE receives a first PDSCH, the indication information in the DCI of a PDCCH for scheduling this PDSCH is indicative of not feeding back HARQ-ACK, and the DAI in the DCI is equal to 1. The UE receives a second PDSCH, the indication information in the DCI of a PDCCH for scheduling this PDSCH is indicative of not feeding back HARQ-ACK, and the DAI in the DCI is equal to 2. The UE receives a third PDSCH, the indication information in the DCI of a PDCCH for scheduling this PDSCH is indicative of not feeding back HARQ-ACK, and the DAI in the DCI is equal to 3. At this time, during the calculation of the number of bits of the HARQ-ACK information, the HARQ-ACK information of the first PDSCH, the second PDSCH and the third PDSCH is considered as HARQ-ACK to be not fed back.

This method has the following advantages: when the mode of feeding back HARQ-ACK by some UEs among UEs that receive a same PDSCH is feeding back HARQ-ACK and the mode of feeding back HARQ-ACK by some UEs is determining according to the indication information whether the UEs feed back HARQ-ACK, it can be avoided that different UEs have different understandings of DAI counting, and the base station and UEs can be prevented from having inconsistent understandings of the number of bits of the HARQ-ACK information.

Method 2:

When a UE will feed back, on a PUCCH, HARQ-ACK information of at least one PDSCH or PDCCH indicating SPS PDSCH, only the HARQ-ACK information of PDSCHs or PDCCHs indicating SPS PDSCH release indicated as HARQ-ACK to be fed back is calculated, and the HARQ-ACK information of PDSCHs or PDCCHs indicating SPS PDSCH release indicated as HARQ-ACK to be not fed back is not calculated.

That is, in a case where a UE will feed back, on a PUCCH, HARQ-ACK information of more than one PDSCH or PDCCH indicating SPS PDSCH release, during the calculation of the number of bits of the HARQ-ACK information, the HARQ-ACK information of PDSCHs or PDCCHs indicating SPS PDSCH release that are indicated as HARQ-ACK to be fed back by the indication information is taken into consideration, and the HARQ-ACK information of PDSCHs or PDCCHs indicating SPS PDSCH release that are indicated as HARQ-ACK to be not fed back is not taken into consideration.

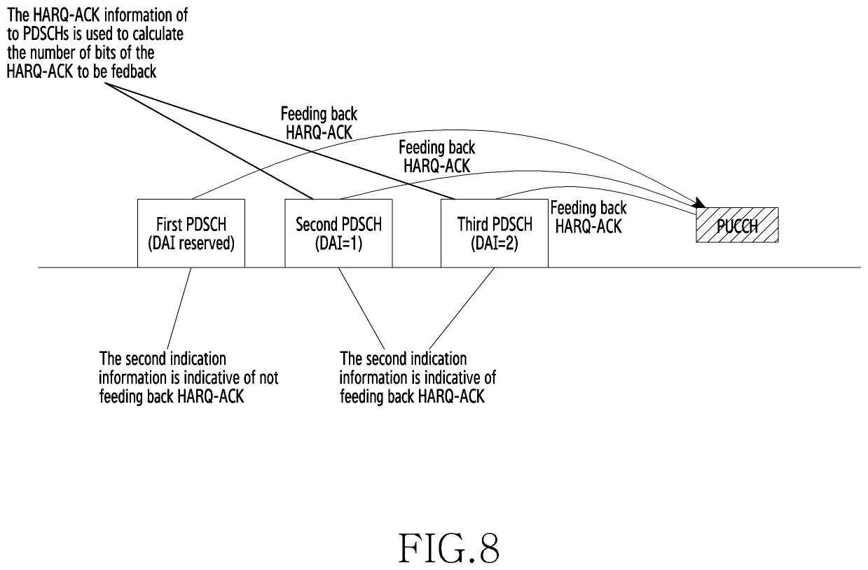

FIG. 8 shows a schematic diagram of another example of transmitting HARQ-ACK information according to an embodiment of the disclosure.

Referring to FIG. 8, the UE receives a first PDSCH, the indication information in the DCI of a PDCCH for scheduling this PDSCH is indicative of not feeding back HARQ-ACK, and the DAI in the DCI is reserved. The UE receives a second PDSCH, the indication information in the DCI of a PDCCH for scheduling this PDSCH is indicative of feeding back HARQ-ACK, and the DAI in the DCI is equal to 1. The UE receives a third PDSCH, the indication information in the DCI of a PDCCH for scheduling this PDSCH is indicative of feeding back HARQ-ACK, and the DAI in the DCI is equal to 2. At this time, during the calculation of the number of bits of the HARQ-ACK information, only the HARQ-ACK information of the second PDSCH and the third PDSCH is considered as HARQ-ACK to be fed back, the HARQ-ACK information of the first PDSCH is HARQ-ACK to be not fed back, and the first PDSCH is not taken into consideration.

This method has the following advantages: the transmission of meaningless HARQ-ACK information can be avoided, and the number of bits of the transmitted HARQ-ACK information can be decreased.

Method 3:

When a UE will feed back, on a PUCCH, HARQ-ACK information of at least one PDSCH or PDCCH indicating SPS PDSCH release, the HARQ-ACK information of the last PDSCH or PDCCH indicating SPS PDSCH release that is indicated as HARQ-ACK to be fed back by the indication information and the HARQ-ACK information of previous PDSCHs or PDCCHs indicating SPS PDSCH release are HARQ-ACK to be fed back, and the HARQ-ACK information of PDSCHs or PDCCHs indicating SPS PDSCH release after the HARQ-ACK information of the last PDSCH or PDCCH indicating SPS PDSCH release is HARQ-ACK to be fed back HARQ-ACK is HARQ-ACK to be not fed back.

That is, in a case where a UE will feed back, on a PUCCH, HARQ-ACK information of more than one PDSCH or PDCCH indicating SPS PDSCH release, during the calculation of the number of bits of the HARQ-ACK information, the HARQ-ACK information of the last PDSCH or PDCCH indicating SPS PDSCH release that is indicated as HARQ-ACK to be fed back by the indication information and the HARQ-ACK information of the previous PDSCHs or PDCCHs indicating SPS PDSCH release are taken into consideration, and the HARQ-ACK information of PDSCHs or PDCCHs indicating SPS PDSCH release after the HARQ-ACK information of the last PDSCH or PDCCH indicating SPS PDSCH release that is indicated as HARQ-ACK to be fed back is not taken into consideration.

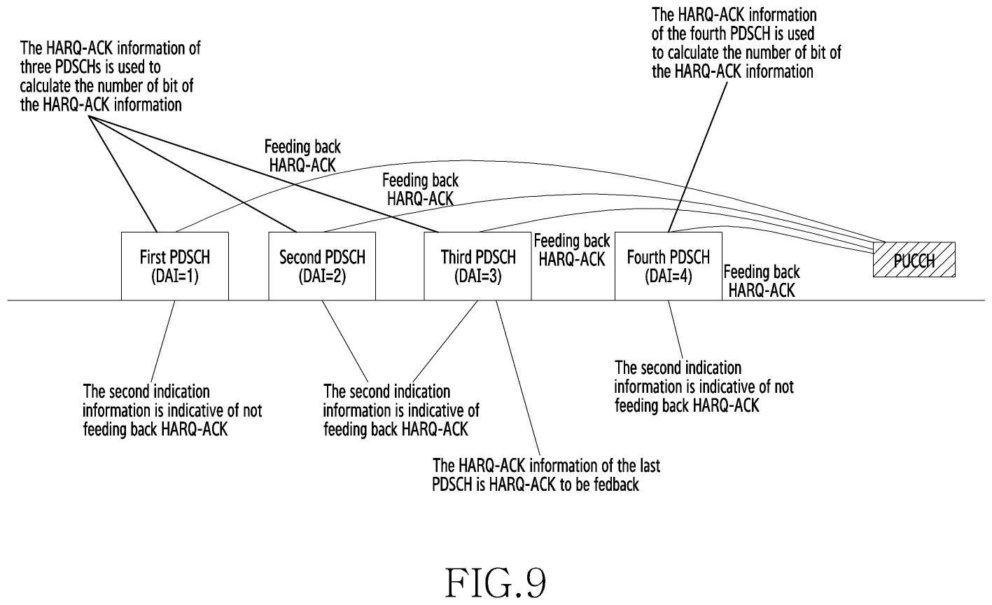

FIG. 9 shows a schematic diagram of another example of transmitting HARQ-ACK information according to an embodiment of the disclosure.

Referring to FIG. 9, the UE receives a first PDSCH, the indication information in the DCI of a PDCCH for scheduling this PDSCH is indicative of not feeding back HARQ-ACK, and the DAI in the DCI is equal to 1. The UE receives a second PDSCH, the indication information in the DCI of a PDCCH for scheduling this PDSCH is indicative of feeding back HARQ-ACK, and the DAI in the DCI is equal to 2. The UE receives a third PDSCH, the indication information in the DCI of a PDCCH for scheduling this PDSCH is indicative of feeding HARQ-ACK, and the DAI in the DCI is equal to 3. The UE receives a fourth PDSCH, the indication information in the DCI of a PDCCH for scheduling this PDSCH is indicative of not feeding back HARQ-ACK, and the DAI in the DCI is equal to 4. At this time, during the calculation of the number of bits of the HARQ-ACK information, it is only considered that the HARQ-ACK information of the first PDSCH, the second PDSCH and the third PDSCH is HARQ-ACK to be fed back and the HARQ-ACK information of the fourth PDSCH is HARQ-ACK to be not fed back; and, during the calculation of the number of bits of the HARQ-ACK information, the HARQ-ACK of the fourth PDSCH is not taken into consideration.

This method has the following advantages: the transmission of meaningless HARQ-ACK information is avoided as far as possible, and the number of bits of the transmitted HARQ-ACK information is decreased.

Method 4:

When a UE will feed back, on a PUCCH, HARQ-ACK information of at least one PDSCH or PDCCH indicating SPS PDSCH, according to whether the HARQ-ACK information of the last PDSCH or PDCCH indicating SPS PDSCH received by the UE is indicated as HARQ-ACK to be fed back or HARQ-ACK to be not fed back by the indication information, it is determined whether the HARQ-ACK information is HARQ-ACK to be fed back or HARQ-ACK to be not fed back. That is, if the HARQ-ACK information of the last PDSCH or PDCCH indicating SPS PDSCH received by the UE is indicated as HARQ-ACK to be fed back by the indication information, the HARQ-ACK information of all PDSCHs or PDCCHs indicating SPS PDSCH received by the UE is HARQ-ACK to be fed back; and, if the HARQ-ACK information of the last PDSCH or PDCCHs indicating SPS PDSCH received by the UE is indicated as HARQ-ACK to be not fed back by the indication information, the HARQ-ACK information of all PDSCHs or PDCCHs indicating SPS PDSCH received by the UE is HARQ-ACK to be not fed back.

That is, in a case where a UE will feed back, on a PUCCH, HARQ-ACK information of more than one PDSCH or PDCCH indicating SPS PDSCH release, during the calculation of the number of bits of the HARQ-ACK information, the HARQ-ACK information of the last received PDSCH or PDCCH indicating SPS PDSCH release is indicated as HARQ-ACK to be fed back by the indication information, all PDSCHs or PDCCHs indicating SPS PDSCH release are taken into consideration; and, if the HARQ-ACK information of the last received PDSCH or PDCCH indicating SPS PDSCH release is indicated as HARQ-ACK to be not fed back by the indication information, all PDSCHs or PDCCHs indicating SPS PDSCH release are not taken into consideration.

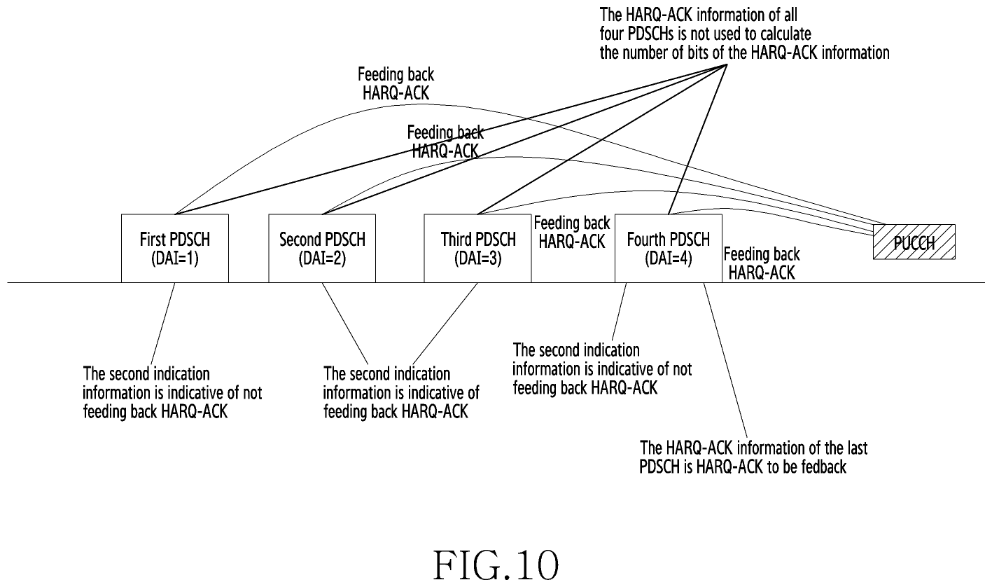

FIG. 10 shows a schematic diagram of another example of transmitting HARQ-ACK information according to an embodiment of the disclosure.

Referring to FIG. 10, the UE receives a first PDSCH, the indication information in the DCI of a PDCCH for scheduling this PDSCH is indicative of not feeding back HARQ-ACK, and the DAI in the DCI is equal to 1. The UE receives a second PDSCH, the indication information in the DCI of a PDCCH for scheduling this PDSCH is indicative of feeding back HARQ-ACK, and the DAI in the DCI is equal to 2. The UE receives a third PDSCH, the indication information in the DCI of a PDCCH for scheduling this PDSCH is indicative of feeding HARQ-ACK, and the DAI in the DCI is equal to 3. The UE receives a fourth PDSCH, the indication information in the DCI of a PDCCH for scheduling this PDSCH is indicative of not feeding back HARQ-ACK, and the DAI in the DCI is equal to 4. At this time, the indication information in the DCI of the PDCCH for the last PDSCH received by the UE is indicative of not feeding back HARQ-ACK; and, during the calculation of the number of bits of the HARQ-ACK information, the HARQ-ACK information of the first PDSCH, the second PDSCH, the third PDSCH and the fourth PDSCH is HARQ-ACK to be not fed back, that is, the UE does not feed back the HARQ-ACK information.

This method has the following advantages: the transmission of meaningless HARQ-ACK information is avoided as far as possible, and the number of bits of the transmitted HARQ-ACK information is decreased.

Method 5:

By receiving configuration information (e.g., high-layer signaling configuration), the UE determines to calculate the bits of the HARQ-ACK information by at least one of the method 1, method 2, method 3 and method 4.

This method has the following advantages: when the mode of feeding back HARQ-ACK by some UEs among UEs that receive a same PDSCH is feeding back HARQ-ACK and the mode of feeding back HARQ-ACK by some UEs is determining according to the indication information whether UEs feed back HARQ-ACK, the UE determines to calculate the number of bits of the HARQ-ACK information by the method 1 by receiving the information configuration (e.g., high-layer signaling configuration), so that the base station and the UE are prevented from having inconsistent understandings of the number of bits of the HARQ-ACK information. When the base station and the UE will not have inconsistent understandings of the number of bits of the HARQ-ACK information, the UE determines to calculate the bits of the HARQ-ACK information by the method 2 by receiving the information configuration (e.g., high-layer signaling configuration), so that the transmission of meaningless HARQ-ACK information can be avoided, and the number of bits of the transmitted HARQ-ACK can be decreased.

### Embodiment 2

There are two modes (also referred to as patterns) of feeding HARQ-ACK by the UE below.

The first mode is as follows: the UE does not feed back HARQ-ACK information if the UE correctly decodes the PDSCH, and the UE feeds back NACK on a PUCCH resource if the UE receives the PDCCH but does not correctly decodes the PDSCH. This mode of feeding back HARQ-ACK by the UE is called a NACK-only mode.

The second mode is as follows: the UE feed backs ACK on a PUCCH resource if the UE correctly decodes the PDSCH, and the UE feeds back NACK on a PUCCH resource if the UE receives the PDCCH but does not correctly decode the PDSCH. This mode of feeding back HARQ-ACK by the UE is called an ACK/NACK mode.

The UE receives two types of PDSCHs, i.e., a first type of PDSCHs and a second type of PDSCHs, wherein unicast PDSCHs are called the first type of PDSCHs. In the disclosure, except for those clearly indicated as unicast PDSCHs, other PDSCHs are considered as the second type of PDSCHs. For example, the second type of PDSCHs is multicast PDSCHs.

### Example 2-1

When the UE is configured with a Type-1 HARQ-ACK codebook, that is, when the UE is configured with pdsch-HARQ-ACK-Codebook=semi-static, the UE is configured with the NACK-only mode of feeding back HARQ-ACK by the UE.

In a first case, if the UE receives activated semi-persistent (also referred to as semi-static) SPS PDSCHs (i.e., SPS activation PDSCHs) and other PDSCHs or receives PDCCHs (which may also indicate SPS PDSCH release DCI, SPS PDSCH deactivation DCI) indicating SPS PDSCH release (also referred to as deactivation) and other PDSCHs, there are several methods for feeding back HARQ-ACK information by the UE below.

Method 1:

The UE feeds back only the HARQ-ACK information of the activated semi-persistent SPS PDSCHs (i.e., SPS activation PDSCHs) or the HARQ-ACK information of the PDCCHs (which may also indicate SPS PDSCH release DCI, SPS PDSCH deactivation DCI) indicating SPS PDSCH release, but does not feed back the HARQ-ACK information of other PDSCHs.

This method has the advantage that the PUCCH resources can be saved.

Method 2:

The UE feeds back the HARQ-ACK information of the activated semi-persistent SPS PDSCHs (i.e., SPS activation PDSCHs) or the HARQ-ACK information of the PDCCHs indicating SPS PDSCH release and the HARQ-ACK information of other PDSCHs in an ACK/NACK mode.

This method has the advantage that all HARQ-ACK information can be transmitted.

In a second case, if the UE only receives activated semi-persistent SPS PDSCHs (i.e., SPS activation PDSCHs) or PDCCHs indicating SPS PDSCH release, there are several methods for feeding back HARQ-ACK information by the UE below.

Method 1:

The UE only feeds back the HARQ-ACK information of the activated semi-persistent SPS PDSCHs (i.e., SPS activation PDSCHs) or the HARQ-ACK information of the PDCCHs indicating SPS PDSCH release. At this time, the HARQ-ACK information fed back by the UE is not determined according to the Type-1 HARQ-ACK codebook.

By using this method, the resources occupied by PUCCHs for transmitting the HARQ-ACK information can be saved.

Method 2:

If the UE only receives activated semi-persistent SPS PDSCHs (i.e., SPS activation PDSCHs) or PDCCHs indicating SPS PDSCH release, the HARQ-ACK information fed back by the UE is determined according to the Type-1 HARQ-ACK codebook.

This method has the advantage that the base station and the UE are prevented from having inconsistent understandings of the number of bits of the HARQ-ACK information.

### Example 2-2

When the UE is configured with the NACK-only mode of feeding back HARQ-ACK by the UE, the UE is configured with a PUCCH resource (PUCCH-Config-1) for transmitting HARQ-ACK, and the UE has a PUCCH resource (PUCCH-Config-2) for transmitting the HARQ-ACK information of unicast PDSCHs. When the UE adopts the NACK-only mode of feeding back HARQ-ACK by the UE, the UE transmits HARQ-ACK by using the PUCCH-Config-1 resource. When the UE transmits the HARQ-ACK of unicast PDSCHs, the UE transmits the HARQ-ACK by using the PUCCH-Config-2 resource.

When the UE transmits the HARQ-ACK information of the activated semi-persistent SPS PDSCHs (i.e., SPS activation PDSCHs) or the HARQ-ACK information of the PDCCHs (which may also indicate SPS PDSCH release DCI, SPS deactivation DCI) indicating SPS PDSCH release, there are several methods for determining the PUCCH resource for transmitting HARQ-ACK below.

Method 1:

When the UE only feeds back the HARQ-ACK information of the activated semi-persistent SPS PDSCHs (i.e., SPS activation PDSCHs) or the HARQ-ACK information of the PDCCHs indicating SPS PDSCH release, the UE transmits the HARQ-ACK information of the activated semi-persistent SPS PDSCHs (i.e., SPS activation PDSCHs) or the HARQ-ACK information of the PDCCHs indicating SPS PDSCH release by using the PUCCH resource (PUCCH-Config-2) that is configured for the UE to transmit the HARQ-ACK of unicast PDSCHs.

Method 2:

When the UE only feeds back the HARQ-ACK information of the activated semi-persistent SPS PDSCHs (i.e., SPS activation PDSCHs) or the HARQ-ACK information of the PDCCHs indicating SPS PDSCH release, the UE uses a PUCCH resource (PUCCH-Config-3) that is specially configured for the UE to transmit the HARQ-ACK information of the activated semi-persistent SPS PDSCHs (i.e., SPS activation PDSCHs) or the HARQ-ACK information of the PDCCHs indicating SPS PDSCH release.

Method 3:

If the UE is configured with the PUCCH resource (PUCCH-Config-3) that is specially configured for the UE to transmit the HARQ-ACK information of the activated semi-persistent SPS PDSCHs (i.e., SPS activation PDSCHs) or the HARQ-ACK information of the PDCCHs indicating SPS PDSCH release, the UE transmits the HARQ-ACK by using the PUCCH resource (PUCCH-Config-3) that is specially configured for the UE to transmit the HARQ-ACK information of the activated semi-persistent SPS PDSCHs (i.e., SPS activation PDSCHs) or the HARQ-ACK information of the PDCCHs indicating SPS PDSCH release; or otherwise, the UE transmits the HARQ-ACK information of the activated semi-persistent SPS PDSCHs (i.e., SPS activation PDSCHs) or the HARQ-ACK information of the PDCCHs indicating SPS PDSCH release by using the PUCCH resource (PUCCH-Config-2) that is configured for the UE to transmit the HARQ-ACK of unicast PDSCHs.

The method of determining a PUCCH resource when the UE only receives activated semi-persistent (also referred to as semi-static) SPS PDSCHs (i.e., SPS activation PDSCHs) or PDCCHs indicating SPS PDSCH release is also applicable to a case where the UE receives activated semi-persistent SPS PDSCHs (i.e., SPS activation PDSCHs) and other PDSCHs or PDCCHs indicating SPS PDSCH release and other PDSCHs.

It is to be noted that, the PUCCH resource (PUCCH-Config-1) configured for the UE to transmit HARQ-ACK is an example of the above first uplink resource, the PUCCH resource (PUCCH-Config-2) configured for the UE to transmit the HARQ-ACK information of unicast PDSCHs is an example of the above second uplink resource, and the PUCCH resource (PUCCH-Config-3) specially configured for the UE to transmit the HARQ-ACK information of the activated semi-persistent SPS PDSCHs (i.e., SPS activation PDSCHs) or the HARQ-ACK information of the PDCCHs indicating SPS PDSCH release is an example of the above third uplink resource.

### Example 2-3

When the UE is configured with a Type-2 HARQ-ACK codebook, that is, when the UE is configured with pdsch-HARQ-ACK-Codebook=dynamic, the UE is configured with the NACK-only mode of feeding back HARQ-ACK by the UE.

If the UE receives activated semi-persistent SPS PDSCHs (i.e., SPS activation PDSCHs) and other PDSCHs or PDCCHs (which may also indicate SPS PDSCH release DCI, SPS deactivation DCI) indicating SPS PDSCH release and other PDSCHs, there are several methods for feeding back HARQ-ACK information by the UE below.

Method 1:

The UE only feeds back the HARQ-ACK information of the activated semi-persistent SPS PDSCHs (i.e., SPS activation PDSCHs) or the HARQ-ACK information of the PDCCHs indicating SPS PDSCH release, but does not feed back the HARQ-ACK information of other PDSCHs. This method has the following advantages: the PUCCH resources can be saved, and it is unnecessary for the UE to configure PUCCH resources of an ACK/NACK transmission mode capable of transmitting a plurality of bits.

Method 2:

The UE feeds back the HARQ-ACK information of the activated semi-persistent SPS PDSCHs (i.e., SPS activation PDSCHs) or the HARQ-ACK information of the PDCCHs indicating SPS PDSCHs and the HARQ-ACK information of other PDSCHs in an ACK/NACK mode. This method has the advantage that all HARQ-ACK information can be transmitted.

Method 3:

The UE does not expect to receive the activated semi-persistent SPS PDSCHs (i.e., SPS activation PDSCHs) and other PDSCHs fed back on a PUCCH (an example of the above uplink resource), and the UE does not expect to receive the PDCCHs indicting SPS PDSCH release and other PDSCHs fed back on a PUCCH. By this method, the implementation of the protocol is simplified.

Based on the same principle as the method according to the embodiments of the disclosure, an embodiment of the disclosure further provides another user equipment, which may comprise a first receiving module and a first transmitting module, wherein:

the first receiving module is configured to receive first configuration information from a base station, the first configuration information being used to configure a mode of feeding back HARQ-ACK information; and

the first transmitting module is configured to transmit HARQ-ACK information according to the first configuration information.

Optionally, the mode of feeding back HARQ-ACK information by the UE comprises at least one of the following:

the UE feeds back HARQ-ACK information;

the UE does not feed back HARQ-ACK information; and

The UE feeds back HARQ-ACK information or not according to indication information.

The indication information may be carried in downlink control information (DCI) in a physical downlink control channel (PDCCH) for scheduling a physical downlink shared channel (PDSCH).

Optionally, if the mode of feeding back HARQ-ACK information is feeding back HARQ-ACK information or mote according to indication information, the user equipment further comprises a processing module, wherein:

the first receiving module is further configured to receive a downlink assignment index (DAI); and

the processing module is configured to determine the number of bits of HARQ-ACK information, and is further configured to generate the HARQ-ACK information according to the number of bits of HARQ-ACK information.

Optionally, a counting mode for the DAI is one of the following:

a first counting mode is counting scheduled PDSCHs and PDCCHs indicating SPS PDSCH release that are indicated as HARQ-ACK information to be fed back by the indication information;

a second counting mode is counting scheduled PDSCHs and PDCCHs indicating SPS PDSCH release that are indicated as HARQ-ACK information to be fed back by the indication information, and scheduled PDSCHs and PDCCHs indicating SPS PDSCH release that are indicated as HARQ-ACK information to be not fed back by the indication information; and

a third counting mode is determining, according to second configuration information from the base station, to perform counting in the first counting mode or the second counting mode.

The second configuration information may be configured by the base station through a high-layer signaling.

Optionally, the determining the number of bits of HARQ-ACK information comprises at least one of the following:

a first mode is calculating the HARQ-ACK information of PDSCHs or PDCCHs indicating SPS PDSCH release that are indicated as HARQ-ACK information to be fed back by the indication information, among the PDSCHs or PDCCHs indicating SPS PDSCH release received by the UE;

a second mode is calculating the HARQ-ACK information of all PDSCHs or PDCCHs indicating SPS PDSCH release if the HARQ-ACK information of at least one PDSCH or PDCCH indicating SPS PDSCH release, among the PDSCHs or PDCCHs indicating SPS PDSCH release received by the UE, is indicated as HARQ-ACK information to be fed back by the indication information;

a third mode is calculating the HARQ-ACK information of the last PDSCH or PDCCH indicating SPS PDSCH release that is indicated as HARQ-ACK information to be fed back by the indication information and the HARQ-ACK information of all previous PDSCH or PDCCHs indicating SPS PDSCH, among the PDSCHs or PDCCHs indicating SPS PDSCH release received by the UE;

a fourth mode is calculating the HARQ-ACK information of all received PDSCHs or PDCCHs indicating SPS PDSCH release if the HARQ-ACK information of the last PDSCH or PDCCH indicating SPS PDSCH release received by the UE is indicated as HARQ-ACK to be fed back by the indication information; and

a fifth mode is determining, according to third configuration information, to perform calculation in one of the first mode, the second mode, the third mode and the fourth mode.

The third configuration information may be configured by the base station through a high-layer signaling.

Optionally, the mode of feeding back HARQ-ACK by the UE comprises one of a first feedback mode and a second feedback mode, wherein the first feedback mode is a NACK-only mode, and the second feedback mode is an ACK/NACK mode.

Optionally, if the mode of feeding back HARQ-ACK is the first feedback mode, the processing module is further configured to:

determine HARQ-ACK information to be fed back.

Optionally, if the UE is configured with a type-1 HARQ-ACK codebook, the processing module is specifically configured to execute any one of the following:

if the UE receives activated semi-static SPS PDSCHs or PDCCHs indicating SPS PDSCH release, determine to feed back the HARQ-ACK information of the activated SPS PDSCHs or the HARQ-ACK information of the PDCCHs indicating SPS PDSCH release;

if the UE receives activated semi-static SPS PDSCHs or PDCCHs indicating SPS PDSCH release, determine to feed back the HARQ-ACK information of the activated SPS PDSCHs or the HARQ-ACK information of the PDCCHs indicating SPS PDSCH release, the number of bits of the HARQ-ACK information to be fed back being determined according to the type-1 HARQ-ACK codebook configured for the UE;

if the UE receives activated SPS PDCCHs and other PDSCHs or PDSCHs indicating SPS PDSCH release and other PDSCHs, determine to feed back the HARQ-ACK information of the activated SPS PDSCHs or the HARQ-ACK information of the PDCCHs indicating SPS PDSCH release; and

if the UE receives activated SPS PDSCHs and other PDSCHs or PDCCHs indicating SPS PDSCH release and other PDSCHs, determine to feed back the HARQ-ACK information of the activated SPS PDSCHs and the HARQ-ACK information of the other PDSCHs in the second feedback mode, or determine to feed back the HARQ-ACK information of the PDCCH indicating SPS PDSCH release and the HARQ-ACK information of the other PDSCHs in the second feedback mode.

The type-1 HARQ-ACK codebook is a semi-static HARQ-ACK codebook.

Optionally, the PDSCHs received by the UE comprises a first type of PDSCHs and a second type of PDSCHs; if the mode of feeding back HARQ-ACK is the first feedback mode, the UE is configured with a first uplink resource for transmitting HARQ-ACK information and a second uplink resource for transmitting HARQ-ACK information of the first type of PDSCHs; and, the processing module is further configured to:

if the UE feeds back HARQ-ACK information in the first feedback mode, transmit the HARQ-ACK information by using the first uplink resource; or,

if the UE transmits the HARQ-ACK information of the first type of PDSCHs, transmit the HARQ-ACK information by using the second uplink resource;

or,

if the UE transmits the HARQ-ACK information of the activated SPS PDSCHs or the HARQ-ACK information of the PDCCHs indicating SPS PDSCH release, transmit the HARQ-ACK information by using the second uplink resource or a third uplink resource,

wherein the third uplink resource is an uplink resource configured to transmit the HARQ-ACK information of the activated SPS PDSCHs or the HARQ-ACK information of the PDCCHs indicating SPS PDSCH release; or,

if the UE transmits the HARQ-ACK information of the activated SPS PDSCHs and the HARQ-ACK information of the other PDSCHs or if the UE transmits the HARQ-ACK information of the PDCCHs indicating SPS PDSCH release and the HARQ-ACK information of the other PDSCHs, transmit the HARQ-ACK information by using the second uplink resource or the third uplink resource.

Optionally, when the HARQ-ACK information is transmitted by using the second uplink resource or the third uplink resource, the processing module is specifically configured to:

if the UE is configured with the third uplink resource, determine that the UE transmits the HARQ-ACK information by using the third uplink resource; and

if the UE is not configured with the third uplink resource, determine that the UE transmits the HARQ-ACK information by using the second uplink resource.

Optionally, if the UE is configured with a type-2 HARQ-ACK codebook, the processing module is specifically configured to execute any one of the following:

if the UE receives activated SPS PDCCHs and other PDSCHs or PDSCHs indicating SPS PDSCH release and other PDSCHs, determine to feed back the HARQ-ACK information of the activated SPS PDSCHs or the HARQ-ACK information of the PDCCHs indicating SPS PDSCH release; and

if the UE receives activated SPS PDSCHs and other PDSCHs or PDCCHs indicating SPS PDSCH release and other PDSCHs, determine to feed back the HARQ-ACK information of the activated SPS PDSCHs and the HARQ-ACK information of the other PDSCHs in the second feedback mode, or determine to feed back the HARQ-ACK information of the PDCCH indicating SPS PDSCH release and the HARQ-ACK information of the other PDSCHs in the second feedback mode; and

not expect the UE to receive, on one uplink resource, information of the activated SPS PDSCHs and other PDSCHs or information of the PUCCHs indicating SPS PDSCH release and other PDSCHs.

The type-2 HARQ-ACK codebook is a dynamic HARQ-ACK codebook.

Based on the same principle as the method according to the embodiments of the disclosure, an embodiment of the disclosure further provides another base station device, which may comprise a second receiving module and a second transmitting module, wherein:

a second transmitting module is configured to transmit first configuration information to a user equipment (UE), the first configuration information being used to configure a mode of feeding back HARQ-ACK information; and

a second receiving module is configured to receive HARQ-ACK information according to the first configuration information.

In this embodiment, the second transmitting module may the first configuration information through a high-layer signaling or a medium access layer signaling.

In some embodiments, the mode of feeding back HARQ-ACK information comprises at least one of the following:

feeding back HARQ-ACK information;

not feeding back HARQ-ACK information; and

feeding back HARQ-ACK information or not according to indication information.

In other embodiments, if the mode of feeding back HARQ-ACK information is feeding back HARQ-ACK information or not according to the indication information, the transmitting module is further configured to:

transmit a downlink assignment index (DAI) to the UE, a counting mode for the DAI being one of the following:

a first counting mode is counting scheduled PDSCHs and PDCCHs indicating SPS PDSCH release that are indicated as HARQ-ACK information to be fed back by the indication information;

a second counting mode is counting scheduled PDSCHs and PDCCHs indicating SPS PDSCH release that are indicated as HARQ-ACK information to be fed back by the indication information, and scheduled PDSCHs and PDCCHs indicating SPS PDSCH release that are indicated as HARQ-ACK information to be not fed back by the indication information; and

a third counting mode is determining, according to second configuration information from the base station, to perform counting in the first counting mode or the second counting mode.

Based on the same principle as the methods according to the embodiments of the disclosure, an embodiment of the disclosure provides an electronic device, comprising: a memory and a storage; and, at least one program, which is stored in the memory and can implement the method according to any one of the optional embodiments of the disclosure when executed by the processor. Optionally, the electronic device may be implemented as a user equipment, and the device contains at least one processor configured to execute the method executed by a user equipment according to any one of the optional embodiments of the disclosure. Optionally, the electronic device may be implemented as a base station, and the device contains at least one processor configured to execute the method executed by a base station according to any one of the optional embodiments of the disclosure.

FIG. 11 is a block diagram of a structure of a UE according to an embodiment of the disclosure.

Referring to FIG. 11, the UE according to an embodiment may include a transceiver 1110, a memory 1120, and a processor 1130. The transceiver 1110, the memory 1120, and the processor 1130 of the UE may operate according to a communication method of the UE described above. However, the components of the UE are not limited thereto. For example, the UE may include more or fewer components than those described above. In addition, the processor 1130, the transceiver 1110, and the memory 1120 may be implemented as a single chip. Also, the processor 1130 may include at least one processor. Furthermore, the UE of FIG. 11 corresponds to the UEs shown in wireless network 100 of FIG. 1. In addition to, the UE of FIG. 11 corresponds to the UE 116 of FIG. 3A.

The transceiver 1110 collectively refers to a UE receiver and a UE transmitter, and may transmit/receive a signal to/from a base station or a network entity. The signal transmitted or received to or from the base station or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the UE. Also, the memory 1120 may store control information or data included in a signal obtained by the UE. The memory 1120 may be a storage medium, such as read-only memory (ROM), random access memory (RAM), a hard disk, a CD-ROM, and a DVD, or a combination of storage media.

The processor 1130 may control a series of processes such that the UE operates as described above. For example, the transceiver 1110 may receive a data signal including a control signal transmitted by the base station or the network entity, and the processor 1130 may determine a result of receiving the control signal and the data signal transmitted by the base station or the network entity.

FIG. 12 illustrates a structure of a base station according to an embodiment of the disclosure.

Referring to FIG. 12, the base station according to an embodiment may include a transceiver 1210, a memory 1220, and a processor 1230. The transceiver 1210, the memory 1220, and the processor 1230 of the base station may operate according to a communication method of the base station described above. However, the components of the base station are not limited thereto. For example, the base station may include more or fewer components than those described above. In addition, the processor 1230, the transceiver 1210, and the memory 1220 may be implemented as a single chip. Also, the processor 1230 may include at least one processor. Furthermore, the base station of FIG. 12 corresponds to the gNB 102 of FIG. 3B.

The transceiver 1210 collectively refers to a base station receiver and a base station transmitter, and may transmit/receive a signal to/from a terminal (UE) or a network entity. The signal transmitted or received to or from the terminal or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the base station. Also, the memory 1220 may store control information or data included in a signal obtained by the base station. The memory 1220 may be a storage medium, such as read-only memory (ROM), random access memory (RAM), a hard disk, a CD-ROM, and a DVD, or a combination of storage media.

The processor 1230 may control a series of processes such that the base station operates as described above. For example, the transceiver 1210 may receive a data signal including a control signal transmitted by the terminal, and the processor 1230 may determine a result of receiving the control signal and the data signal transmitted by the terminal.

In one embodiment, a method for transmitting hybrid automatic repeat request acknowledgement (HARQ-ACK) information, comprising steps of: receiving first configuration information from a base station, the first configuration information being used to configure a mode of feeding back HARQ-ACK information; and transmitting HARQ-ACK information according to the first configuration information.

In one embodiment, wherein the mode of feeding back HARQ-ACK information comprises at least one of the following: feeding back HARQ-ACK information; not feeding back HARQ-ACK information; and feeding back HARQ-ACK information or not according to indication information.

In one embodiment, wherein, if the mode of feeding back HARQ-ACK information by a UE is feeding back HARQ-ACK information or not according to indication information, before transmitting HARQ-ACK information, the method further comprises: receiving a downlink assignment index (DAI); determining the number of bits of HARQ-ACK information; and generating the HARQ-ACK information according to the number of bits of HARQ-ACK information.

In one embodiment, wherein a counting mode for the DAI is one of the following: a first counting mode is counting scheduled PDSCHs and PDCCHs indicating SPS PDSCH release that are indicated as HARQ-ACK information to be fed back by the indication information; a second counting mode is counting scheduled PDSCHs and PDCCHs indicating SPS PDSCH release that are indicated as HARQ-ACK information to be fed back by the indication information, and scheduled PDSCHs and PDCCHs indicating SPS PDSCH release that are indicated as HARQ-ACK information to be not fed back by the indication information; and a third counting mode is determining, according to second configuration information from the base station, to perform counting in the first counting mode or the second counting mode.

In one embodiment, wherein the determining the number of bits of HARQ-ACK information comprises at least one of the following: a first mode is calculating the HARQ-ACK information of PDSCHs or PDCCHs indicating SPS PDSCH release that are indicated as HARQ-ACK information to be fed back by the indication information, among the PDSCHs or PDCCHs indicating SPS PDSCH release received by the UE; a second mode is calculating the HARQ-ACK information of all PDSCHs or PDCCHs indicating SPS PDSCH release if the HARQ-ACK information of at least one PDSCH or PDCCH indicating SPS PDSCH release, among the PDSCHs or PDCCHs indicating SPS PDSCH release received by the UE, is indicated as HARQ-ACK information to be fed back by the indication information; a third mode is calculating the HARQ-ACK information of the last PDSCH or PDCCH indicating SPS PDSCH release that is indicated as HARQ-ACK information to be fed back by the indication information and the HARQ-ACK information of all previous PDSCH or PDCCHs indicating SPS PDSCH, among the PDSCHs or PDCCHs indicating SPS PDSCH release received by the UE; a fourth mode is calculating the HARQ-ACK information of all received PDSCHs or PDCCHs indicating SPS PDSCH release if the HARQ-ACK information of the last PDSCH or PDCCH indicating SPS PDSCH release received by the UE is indicated as HARQ-ACK to be fed back by the indication information; and a fifth mode is determining, according to third configuration information, to perform calculation in one of the first mode, the second mode, the third mode and the fourth mode.

In one embodiment, a method is provided. The method further comprises receiving, through a high-layer signaling or a medium access layer signaling, the first configuration information configured by the base station.

In one embodiment, wherein the mode of feeding back HARQ-ACK comprises one of a first feedback mode and a second feedback mode, wherein the first feedback mode is a NACK-only mode, and the second feedback mode is an ACK/NACK mode.

In one embodiment, wherein if the mode of feeding back HARQ-ACK is the first feedback mode, before transmitting HARQ-ACK information, the method further comprises: determining HARQ-ACK information to be fed back, wherein the determining HARQ-ACK information to be fed back comprises any one of the following: if the UE receives activated semi-static SPS PDSCHs or PDCCHs indicating SPS PDSCH release, determining to feed back the HARQ-ACK information of the activated SPS PDSCHs or the HARQ-ACK information of the PDCCHs indicating SPS PDSCH release; if the UE receives activated semi-static SPS PDSCHs or PDCCHs indicating SPS PDSCH release, determining to feed back the HARQ-ACK information of the activated SPS PDSCHs or the HARQ-ACK information of the PDCCHs indicating SPS PDSCH release, the number of bits of the HARQ-ACK information to be fed back being determined according to a type-1 HARQ-ACK codebook configured for the UE; if the UE receives activated SPS PDCCHs and other PDSCHs or PDSCHs indicating SPS PDSCH release and other PDSCHs, determining to feed back the HARQ-ACK information of the activated SPS PDSCHs or the HARQ-ACK information of the PDCCHs indicating SPS PDSCH release; and if the UE receives activated SPS PDSCHs and other PDSCHs or PDCCHs indicating SPS PDSCH release and other PDSCHs, determining to feed back the HARQ-ACK information of the activated SPS PDSCHs and the HARQ-ACK information of the other PDSCHs in the second feedback mode, or determining to feed back the HARQ-ACK information of the PDCCH indicating SPS PDSCH release and the HARQ-ACK information of the other PDSCHs in the second feedback mode.

In one embodiment, wherein the PDSCHs received by the UE comprises a first type of PDSCHs and a second type of PDSCHs; and, if the mode of feeding back HARQ-ACK is the first feedback mode, the UE is configured with a first uplink resource for transmitting HARQ-ACK information and a second uplink resource for transmitting HARQ-ACK information of the first type of PDSCHs; the method further comprises: if the UE feeds back HARQ-ACK information in the first feedback mode, transmitting the HARQ-ACK information by using the first uplink resource; or, if the UE transmits the HARQ-ACK information of the first type of PDSCHs, transmitting the HARQ-ACK information by using the second uplink resource; or, if the UE transmits the HARQ-ACK information of the activated SPS PDSCHs or the HARQ-ACK information of the PDCCHs indicating SPS PDSCH release, transmitting the HARQ-ACK information by using the second uplink resource or a third uplink resource, wherein the third uplink resource is an uplink resource configured to transmit the HARQ-ACK information of the activated SPS PDSCHs or the HARQ-ACK information of the PDCCHs indicating SPS PDSCH release; or, if the UE transmits the HARQ-ACK information of the activated SPS PDSCHs and the HARQ-ACK information of the other PDSCHs or if the UE transmits the HARQ-ACK information of the PDCCHs indicating SPS PDSCH release and the HARQ-ACK information of the other PDSCHs, transmitting the HARQ-ACK information by using the second uplink resource or the third uplink resource.

In one embodiment, wherein the transmitting the HARQ-ACK information by using the second uplink resource or the third uplink resource comprises: if the UE is configured with the third uplink resource, transmitting the HARQ-ACK information by using the third uplink resource; and if the UE is not configured with the third uplink resource, transmitting the HARQ-ACK information by using the second uplink resource.

In one embodiment, wherein the determining HARQ-ACK information to be fed back according to the information received by the UE further comprises: if the UE is configured with a type-2 HARQ-ACK codebook, not expecting the UE to receive, on one uplink resource, information of the activated SPS PDSCHs and other PDSCHs or information of the PUCCHs indicating SPS PDSCH release and other PDSCHs.

In one embodiment, a method for receiving hybrid automatic repeat request acknowledgement (HARQ-ACK) information, comprising steps of: transmitting first configuration information to a user equipment (UE), the first configuration information being used to configure a mode of feeding back HARQ-ACK information; and receiving HARQ-ACK information according to the first configuration information.

In one embodiment, wherein the mode of feeding back HARQ-ACK information comprises at least one of the following: feeding back HARQ-ACK information; not feeding back HARQ-ACK information; and feeding back HARQ-ACK information or not according to indication information.

In one embodiment, wherein, if the mode of feeding back HARQ-ACK information is feeding back HARQ-ACK information or not according to indication information, before receiving HARQ-ACK information, the method further comprises: transmitting a downlink assignment index (DAI) to the UE, a counting mode for the DAI being one of the following: a first counting mode is counting scheduled PDSCHs and PDCCHs indicating SPS PDSCH release that are indicated as HARQ-ACK information to be fed back by the indication information; a second counting mode is counting scheduled PDSCHs and PDCCHs indicating SPS PDSCH release that are indicated as HARQ-ACK information to be fed back by the indication information, and scheduled PDSCHs and PDCCHs indicating SPS PDSCH release that are indicated as HARQ-ACK information to be not fed back by the indication information; and a third counting mode is determining, according to second configuration information from the base station, to perform counting in the first counting mode or the second counting mode.

In one embodiment, the method further includes transmitting the first configuration information through a high-layer signaling or a medium access layer signaling.

In one embodiment, wherein the mode of feeding back HARQ-ACK comprises one of a first feedback mode and a second feedback mode, wherein the first feedback mode is an NACK-only mode, and the second feedback mode is an ACK/NACK mode.

In one embodiment, a user equipment is provided. The UE includes a transceiver; a processor; and coupled with the transceiver and configured to: receive first configuration information from a base station, the first configuration information being used to configure a mode of feeding back HARQ-ACK information, and transmit HARQ-ACK information according to the first configuration information.

In one embodiment, wherein the mode of feeding back HARQ-ACK information comprises at least one of the following: feedback HARQ-ACK information, not feedback HARQ-ACK information, and feedback HARQ-ACK information or not according to indication information.

In one embodiment, wherein if the mode of feeding back HARQ-ACK information by a UE is feeding back HARQ-ACK information or not according to indication information, before transmitting HARQ-ACK information, the method further comprises: receive a downlink assignment index (DAI), determine the number of bits of HARQ-ACK information, and generate the HARQ-ACK information according to the number of bits of HARQ-ACK information.

In one embodiment, wherein a counting mode for the DAI is one of the following: a first counting mode is counting scheduled PDSCHs and PDCCHs indicating SPS PDSCH release that are indicated as HARQ-ACK information to be fed back by the indication information, a second counting mode is counting scheduled PDSCHs and PDCCHs indicating SPS PDSCH release that are indicated as HARQ-ACK information to be fed back by the indication information, and scheduled PDSCHs and PDCCHs indicating SPS PDSCH release that are indicated as HARQ-ACK information to be not fed back by the indication information, and a third counting mode is determining, according to second configuration information from the base station, to perform counting in the first counting mode or the second counting mode.

In one embodiment, wherein the determining the number of bits of HARQ-ACK information comprises at least one of the following: a first mode is calculating the HARQ-ACK information of PDSCHs or PDCCHs indicating SPS PDSCH release that are indicated as HARQ-ACK information to be fed back by the indication information, among the PDSCHs or PDCCHs indicating SPS PDSCH release received by the UE; a second mode is calculating the HARQ-ACK information of all PDSCHs or PDCCHs indicating SPS PDSCH release if the HARQ-ACK information of at least one PDSCH or PDCCH indicating SPS PDSCH release, among the PDSCHs or PDCCHs indicating SPS PDSCH release received by the UE, is indicated as HARQ-ACK information to be fed back by the indication information; a third mode is calculating the HARQ-ACK information of the last PDSCH or PDCCH indicating SPS PDSCH release that is indicated as HARQ-ACK information to be fed back by the indication information and the HARQ-ACK information of all previous PDSCH or PDCCHs indicating SPS PDSCH, among the PDSCHs or PDCCHs indicating SPS PDSCH release received by the UE; a fourth mode is calculating the HARQ-ACK information of all received PDSCHs or PDCCHs indicating SPS PDSCH release if the HARQ-ACK information of the last PDSCH or PDCCH indicating SPS PDSCH release received by the UE is indicated as HARQ-ACK to be fed back by the indication information; and a fifth mode is determining, according to third configuration information, to perform calculation in one of the first mode, the second mode, the third mode and the fourth mode.

In one embodiment, further comprising: receive, through a high-layer signaling or a medium access layer signaling, the first configuration information configured by the base station.

In one embodiment, wherein the mode of feeding back HARQ-ACK comprises one of a first feedback mode and a second feedback mode, wherein the first feedback mode is a NACK-only mode, and the second feedback mode is an ACK/NACK mode.

In one embodiment, wherein, if the mode of feeding back HARQ-ACK is the first feedback mode, before transmitting HARQ-ACK information, the method further comprises: determine HARQ-ACK information to be fed back, wherein the determining HARQ-ACK information to be fed back comprises any one of the following: if the UE receives activated semi-static SPS PDSCHs or PDCCHs indicating SPS PDSCH release, determine to feed back the HARQ-ACK information of the activated SPS PDSCHs or the HARQ-ACK information of the PDCCHs indicating SPS PDSCH release; if the UE receives activated semi-static SPS PDSCHs or PDCCHs indicating SPS PDSCH release, determine to feed back the HARQ-ACK information of the activated SPS PDSCHs or the HARQ-ACK information of the PDCCHs indicating SPS PDSCH release, the number of bits of the HARQ-ACK information to be fed back being determined according to a type-1 HARQ-ACK codebook configured for the UE; if the UE receives activated SPS PDCCHs and other PDSCHs or PDSCHs indicating SPS PDSCH release and other PDSCHs, determining to feed back the HARQ-ACK information of the activated SPS PDSCHs or the HARQ-ACK information of the PDCCHs indicating SPS PDSCH release; and if the UE receives activated SPS PDSCHs and other PDSCHs or PDCCHs indicating SPS PDSCH release and other PDSCHs, determine to feed back the HARQ-ACK information of the activated SPS PDSCHs and the HARQ-ACK information of the other PDSCHs in the second feedback mode, or determine to feed back the HARQ-ACK information of the PDCCH indicating SPS PDSCH release and the HARQ-ACK information of the other PDSCHs in the second feedback mode.

In one embodiment, wherein the PDSCHs received by the UE comprises a first type of PDSCHs and a second type of PDSCHs; and, if the mode of feeding back HARQ-ACK is the first feedback mode, the UE is configured with a first uplink resource for transmitting HARQ-ACK information and a second uplink resource for transmitting HARQ-ACK information of the first type of PDSCHs; the method further comprises: if the UE feeds back HARQ-ACK information in the first feedback mode, transmit the HARQ-ACK information by using the first uplink resource; or, if the UE transmits the HARQ-ACK information of the first type of PDSCHs, transmit the HARQ-ACK information by using the second uplink resource; or, if the UE transmits the HARQ-ACK information of the activated SPS PDSCHs or the HARQ-ACK information of the PDCCHs indicating SPS PDSCH release, transmit the HARQ-ACK information by using the second uplink resource or a third uplink resource, wherein the third uplink resource is an uplink resource configured to transmit the HARQ-ACK information of the activated SPS PDSCHs or the HARQ-ACK information of the PDCCHs indicating SPS PDSCH release; or, if the UE transmits the HARQ-ACK information of the activated SPS PDSCHs and the HARQ-ACK information of the other PDSCHs or if the UE transmits the HARQ-ACK information of the PDCCHs indicating SPS PDSCH release and the HARQ-ACK information of the other PDSCHs, transmit the HARQ-ACK information by using the second uplink resource or the third uplink resource.

In one embodiment, wherein the transmit the HARQ-ACK information by using the second uplink resource or the third uplink resource comprises: if the UE is configured with the third uplink resource, transmit the HARQ-ACK information by using the third uplink resource; and if the UE is not configured with the third uplink resource, transmit the HARQ-ACK information by using the second uplink resource.

In one embodiment, wherein the determine HARQ-ACK information to be fed back according to the information received by the UE further comprises: if the UE is configured with a type-2 HARQ-ACK codebook, not expect the UE to receive, on one uplink resource, information of the activated SPS PDSCHs and other PDSCHs or information of the PUCCHs indicating SPS PDSCH release and other PDSCHs.

The above flowcharts illustrate example methods that can be implemented in accordance with the principles of the disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

The methods according to the embodiments described in the claims or the detailed description of the disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the disclosure. Another storage device on the communication network may also be connected to the apparatus performing the embodiments of the disclosure.

In the afore-described embodiments of the disclosure, elements included in the disclosure are expressed in a singular or plural form according to the embodiments. However, the singular or plural form is appropriately selected for convenience of explanation and the disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

It should be understood that, although the operations in the flowcharts in the accompanying drawings are shown sequentially as indicated by arrows, these operations are not necessarily executed sequentially in the order indicated by the arrows. Unless otherwise clearly stated herein, the execution of these operations is not limited to a strict order and these operations may be executed in other orders. Moreover, at least some of the operations in the flowcharts of the accompanying drawings may comprise a plurality of sub-steps or a plurality of sub-stages. These sub-steps or sub-stages may be executed at different moments rather than at a same moment. These sub-steps or sub-stages are not necessarily executed sequentially, and instead, they may be executed in turn or alternately with other operations or with at least some of sub-steps or sub-stages of other operations.

While the disclosure has been shown and described with reference to various embodiments thereof, it will be understood by those skilled in the art that various changes in form and details can be made therein without departing from the spirit and scope of the disclosure as defined by the appended claims and their equivalents.

What is claimed is:

1. A method performed by a user equipment (UE), the method comprising:
receiving first configuration information from a base station;
configuring a mode of feeding back hybrid automatic repeat request acknowledgement (HARQ-ACK) information based on the first configuration information; and
transmitting the HARQ-ACK information according to the first configuration information.

2. The method of claim 1, wherein the mode of feeding back the HARQ-ACK information comprises at least one of:
feeding back HARQ-ACK information,
not feeding back HARQ-ACK information, or
feeding back HARQ-ACK information or not according to indication information.

3. The method of claim 2, wherein, in case that the mode of feeding back HARQ-ACK information comprises the feeding back of the HARQ-ACK information according to the indication information, the method, before the transmitting of the HARQ-ACK information, further comprises:
receiving a downlink assignment index (DAI);
determining a number of bits of HARQ-ACK information; and
generating the HARQ-ACK information according to the number of bits of HARQ-ACK information.

4. The method of claim 3, wherein a counting mode for the DAI is one of:
a first counting mode is counting scheduled physical downlink shared channels (PDSCHs) and physical downlink control channels (PDCCHs) indicating semi-persistent scheduling (SPS) PDSCH release that are indicated as HARQ-ACK information to be fed back by the indication information,
a second counting mode is counting scheduled PDSCHs and PDCCHs indicating SPS PDSCH release that are indicated as HARQ-ACK information to be fed back by the indication information, and scheduled PDSCHs and PDCCHs indicating SPS PDSCH release that are indicated as HARQ-ACK information to be not fed back by the indication information, or
a third counting mode is determining, according to second configuration information from the base station, to perform counting in the first counting mode or the second counting mode.

5. The method of claim 3, wherein the determining the number of bits of HARQ-ACK information comprises at least one of:
a first mode is calculating HARQ-ACK information of PDSCHs or PDCCHs indicating SPS PDSCH release that are indicated as HARQ-ACK information to be fed back by the indication information, among the PDSCHs or PDCCHs indicating SPS PDSCH release received by the UE;
a second mode is calculating HARQ-ACK information of all PDSCHs or PDCCHs indicating SPS PDSCH release in case that HARQ-ACK information of at least one PDSCH or PDCCH indicating SPS PDSCH release, among the PDSCHs or PDCCHs indicating SPS PDSCH release received by the UE, is indicated as HARQ-ACK information to be fed back by the indication information;
a third mode is calculating the HARQ-ACK information of a last PDSCH or PDCCH indicating SPS PDSCH release that is indicated as HARQ-ACK information to be fed back by the indication information and HARQ-ACK information of all previous PDSCHs or PDCCHs indicating SPS PDSCH, among the PDSCHs or PDCCHs indicating SPS PDSCH release received by the UE;
a fourth mode is calculating HARQ-ACK information of all received PDSCHs or PDCCHs indicating SPS PDSCH release in case that the HARQ-ACK information of the last PDSCH or PDCCH indicating SPS PDSCH release received by the UE is indicated as HARQ-ACK to be fed back by the indication information; or
a fifth mode is determining, according to third configuration information, to perform calculation in one of the first mode, the second mode, the third mode and the fourth mode.

6. The method of claim 1, further comprising:
receiving, through a high-layer signaling or a medium access layer signaling, the first configuration information configured by the base station.

7. The method of claim 1,
wherein the mode of feeding back HARQ-ACK comprises one of a first feedback mode and a second feedback mode, and
wherein the first feedback mode is a negative acknowledgment (NACK)-only mode, and the second feedback mode is an ACK/NACK mode.

8. The method of claim 7,
wherein, in case that the mode of feeding back HARQ-ACK is the first feedback mode, before transmitting HARQ-ACK information, the method further comprises determining HARQ-ACK information to be fed back, and
wherein the determining of the HARQ-ACK information to be fed back comprises one of:
in case that the UE receives activated semi-static SPS PDSCHs or PDCCHs indicating SPS PDSCH release, determining to feed back the HARQ-ACK information of the activated SPS PDSCHs or the HARQ-ACK information of the PDCCHs indicating SPS PDSCH release,
in case that the UE receives activated semi-static SPS PDSCHs or PDCCHs indicating SPS PDSCH release, determining to feed back the HARQ-ACK information of the activated SPS PDSCHs or the HARQ-ACK information of the PDCCHs indicating SPS PDSCH release, a number of bits of the HARQ-ACK information to be fed back being determined according to a type-1 HARQ-ACK codebook configured for the UE,
in case that the UE receives activated SPS PDCCHs and other PDSCHs or PDSCHs indicating SPS PDSCH release and other PDSCHs, determining to feed back the HARQ-ACK information of the activated SPS PDSCHs or the HARQ-ACK information of the PDCCHs indicating SPS PDSCH release, or
in case that the UE receives activated SPS PDSCHs and other PDSCHs or PDCCHs indicating SPS PDSCH release and other PDSCHs, determining to feed back the HARQ-ACK information of the activated SPS PDSCHs and the HARQ-ACK information of the other PDSCHs in the second feedback mode, or determining to feed back the HARQ-ACK information of the PDCCH indicating SPS PDSCH release and the HARQ-ACK information of the other PDSCHs in the second feedback mode.

9. The method of claim 8,
wherein the PDSCHs received by the UE include a first type of PDSCHs and a second type of PDSCHs,
wherein in case that the mode of feeding back HARQ-ACK is the first feedback mode, the UE is configured with a first uplink resource for transmitting HARQ-ACK information and a second uplink resource for transmitting HARQ-ACK information of the first type of PDSCHs,
wherein:
in case that the UE feeds back HARQ-ACK information in the first feedback mode, transmitting the HARQ-ACK information by using the first uplink resource
in case that the UE transmits the HARQ-ACK information of the first type of PDSCHs, transmitting the HARQ-ACK information by using the second uplink resource, or
in case that the UE transmits HARQ-ACK information of activated SPS PDSCHs or HARQ-ACK information of PDCCHs indicating SPS PDSCH release, transmitting the HARQ-ACK information by using the second uplink resource or a third uplink resource,
wherein the third uplink resource is an uplink resource configured to transmit the HARQ-ACK information of the activated SPS PDSCHs or the HARQ-ACK information of the PDCCHs indicating SPS PDSCH release, or
wherein in case that the UE transmits the HARQ-ACK information of the activated SPS PDSCHs and the HARQ-ACK information of the other PDSCHs or in case that the UE transmits the HARQ-ACK information of the PDCCHs indicating SPS PDSCH release and the HARQ-ACK information of the other PDSCHs, transmitting the HARQ-ACK information by using the second uplink resource or the third uplink resource.

10. The method of claim 9, wherein the transmitting of the HARQ-ACK information by using the second uplink resource or the third uplink resource comprises:
in case that the UE is configured with the third uplink resource, transmitting the HARQ-ACK information by using the third uplink resource; and
in case that the UE is not configured with the third uplink resource, transmitting the HARQ-ACK information by using the second uplink resource.

11. The method of claim 8, wherein the determining of the HARQ-ACK information to be fed back according to the first configuration information received by the UE further comprises:
in case that the UE is configured with a type-2 HARQ-ACK codebook, not expecting the UE to receive, on one uplink resource, information of the activated SPS PDSCHs and other PDSCHs or information of PUCCHs indicating SPS PDSCH release and other PDSCHs.

12. A method performed by a base station, the method comprising:
transmitting first configuration information to a user equipment (UE); and
receiving hybrid automatic repeat request acknowledgement (HARQ-ACK) information based on the first configuration information,
wherein the first configuration information is used to configure a mode of feeding back the HARQ-ACK information.

13. The method of claim 12, wherein the mode of feeding back the HARQ-ACK information comprises at least one of:
feeding back HARQ-ACK information,
not feeding back HARQ-ACK information, or
feeding back HARQ-ACK information or not according to indication information.

14. The method of claim 13, wherein, in case that the mode of feeding back HARQ-ACK information comprises the feeding back of the HARQ-ACK information according to the indication information, the method, before the receiving of the HARQ-ACK information, further comprises:
transmitting a downlink assignment index (DAI) to the UE, a counting mode for the DAI being one of:
a first counting mode is counting scheduled PDSCHs and PDCCHs indicating SPS PDSCH release that are indicated as HARQ-ACK information to be fed back by the indication information,
a second counting mode is counting scheduled PDSCHs and PDCCHs indicating SPS PDSCH release that are indicated as HARQ-ACK information to be fed back by the indication information, and scheduled PDSCHs and PDCCHs indicating SPS PDSCH release that are indicated as HARQ-ACK information to be not fed back by the indication information, or
a third counting mode is determining, according to second configuration information from the base station, to perform counting in the first counting mode or the second counting mode.

15. The method of claim 12, further comprising:
transmitting the first configuration information through a high-layer signaling or a medium access layer signaling.

16. The method of claim 12, wherein the mode of feeding back HARQ-ACK comprises one of a first feedback mode and a second feedback mode, wherein the first feedback mode is a NACK-only mode, and the second feedback mode is an ACK/NACK mode.

17. A user equipment (UE) comprising:
a transceiver; and
a processor coupled with the transceiver and configured to:
receive first configuration information from a base station,
configure a mode of feeding back hybrid automatic repeat request acknowledgement (HARQ-ACK) information based on the first configuration information, and
transmit the HARQ-ACK information based on the first configuration information.

18. The UE of claim 17, wherein the mode of feeding back HARQ-ACK information comprises at least one of:
feedback HARQ-ACK information,
not feedback HARQ-ACK information, or
feedback HARQ-ACK information or not according to indication information.

19. The UE of claim 18, wherein in case that the mode of feeding back the HARQ-ACK information comprises the feeding back of the HARQ-ACK information according to the indication information, the processor, before transmitting of the HARQ-ACK information, is further configured to:
receive a downlink assignment index (DAI),
determine a number of bits of HARQ-ACK information, and
generate the HARQ-ACK information according to the number of bits of HARQ-ACK information.

20. The UE of claim 19, wherein a counting mode for the DAI is one of:
a first counting mode is counting scheduled PDSCHs and PDCCHs indicating SPS PDSCH release that are indicated as HARQ-ACK information to be fed back by the indication information;
a second counting mode is counting scheduled PDSCHs and PDCCHs indicating SPS PDSCH release that are indicated as HARQ-ACK information to be fed back by the indication information, and scheduled PDSCHs and PDCCHs indicating SPS PDSCH release that are indicated as HARQ-ACK information to be not fed back by the indication information; or
a third counting mode is determining, according to second configuration information from the base station, to perform counting in the first counting mode or the second counting mode.
